(19) United States
(12) Patent Application Publication
(10) Pub. No.: US 2008/0201746 A1
(43) Pub. Date: Aug. 21, 2008

(54) METHOD AND APPARATUS FOR TRANSMITTING AND RECEIVING ELECTRONIC SERVICE GUIDE IN A DIGITAL BROADCASTING SYSTEM

(75) Inventors: Yiling Xu, Suwon-si (KR); Jae-Yeon Song, Seoul (KR); Kook-Hui Lee, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/966,546

(22) Filed: Dec. 28, 2007

Related U.S. Application Data
(60) Provisional application No. 60/938,595, filed on May 17, 2007.
(60) Provisional application No. 60/942,875, filed on Jun. 8, 2007.

(30) Foreign Application Priority Data
Feb. 16, 2007 (KR) 2007-16831
Mar. 14, 2007 (KR) 2007-25179
Jun. 20, 2007 (KR) 2007-60812

(51) Int. Cl. H04N 5/445

(52) U.S. Cl. 725/54

(57) ABSTRACT

A method for transmitting an Electronic Service Guide (ESG) in a Convergence of Broadcasting and Mobile Service (CBMS) system is provided. A delivery path of ESG data is parsed. A first information element indicating transmission of a broadcast ESG when the ESG data can be delivered over a broadcast network is set. A second information element indicating transmission of a Point-to-Point (PTP) ESG for a terminal or a terminal group when the ESG data can be delivered over an interactive network in a PTP bearer is set. ESG delivery information is transmitted including at least one of the first and second information elements, to at least one terminal over at least one ESG bootstrap session for carrying information necessary for transmission of the ESG data. The broadcast ESG and the PTP ESG are transmitted to the at least one terminal over at least one delivery path out of the broadcast network and the interactive network.

### PRIORITY

This application claims the benefit under 35 U.S.C. § 119(a) of a Korean Patent Application filed in the Korean Intellectual Property Office on Feb. 16, 2007 and assigned Serial No. 2007-16831, a Korean Patent Application filed in the Korean Intellectual Property Office on Mar. 14, 2007 and assigned Serial No. 2007-25179, a Korean Patent Application filed in the Korean Intellectual Property Office on Jun. 20, 2007 and assigned Serial No. 2007-60812, a United States patent Application filed in the United States Patent and Trademark Office on May 17, 2007 and assigned Ser. No. 60/938,595, and a United States patent Application filed in the United States Patent and Trademark Office on Jun. 8, 2007 and assigned Ser. No. 60/942,875, the disclosures of all of which are incorporated herein by reference.

### BACKGROUND OF THE INVENTION

1. Field of the Invention

The present invention relates generally to a digital broadcasting system, and more particularly, to a method and apparatus for transmitting and receiving an Electronic Service Guide (ESG) in Convergence of Broadcasting and Mobile Service (CBMS).

2. Description of the Related Art

Developments in the fields of communication and broadcasting technologies have enabled a broadcasting system or mobile communication system to provide mobile broadcast. There are currently discussions regarding not only the normal broadcast service limited to the voice and image, but also Mobile Broadcast capable of transmitting packet data over a broadcast channel. Mobile Broadcast can include a process of discovering a service by a mobile terminal capable of receiving the Mobile Broadcast, such as a mobile phone, a notebook computer, a Personal Digital Assistant (PDA), etc., a process of making a subscription to a service by the mobile terminal, a process of providing a variety of control information for receiving the service, and a process of transmitting the service and receiving the service by the mobile terminal.

Open Mobile Alliance (OMA), one group studying the standard for interaction between individual mobility solutions, mainly serves to establish various application standards for mobile game, Internet service, and the like. Among OMA Working Groups, OMA Browser and Content (BAC) Mobile Broadcast (BCAST) Sub-Working Group is studying the technology for converging the broadcast service and the mobile communication service using a mobile terminal capable of communication with an interactive network. Digital Video Broadcasting—Convergence of Broadcasting and Mobile Service (DVB-CBMS), one of the Mobile Broadcast terminal standard groups, also defines system configuration and interfaces for converging the broadcast service and the mobile communication service.

Generally, in the Mobile Broadcast system, the terminal for receiving a broadcast service receives a Service Guide (SG) including description information for the service, billing information for the service, and information on a reception bearer of the service, and receives its desired service using the SG. In the foregoing conventional digital broadcasting system, there is a need for technology for transmitting the ESG in a Point-to-Point (PTP) mode.

### SUMMARY OF THE INVENTION

The present invention has been made to address at least the above problems and/or disadvantages and to provide at least the advantages described below. Accordingly, an aspect of the present invention provides a method and apparatus for supporting the transmission/reception of an Electronic Service Guide (ESG) in a Point-to-Point (PTP) mode.

Another aspect of the present invention provides a method and apparatus for delivering information related to broadcast/PTP-mode transmission of an ESG.

An additional aspect of the present invention provides a method and apparatus for receiving an ESG according to information related to broadcast/PTP-mode transmission of an ESG.

According to one aspect of the present invention, a method for transmitting an Electronic Service Guide (ESG) in a Convergence of Broadcasting and Mobile Service (CBMS) system is provided. A delivery path of ESG data is parsed. A first information element indicating transmission of a broadcast ESG is set when the ESG data can be delivered over a broadcast network. A second information element indicating transmission of a Point-to-Point (PTP) ESG for a terminal or a terminal group is set when the ESG data can be delivered over an interactive network in a PTP bearer. ESG delivery information including at least one of the first and second information elements is transmitted to at least one terminal over at least one ESG bootstrap session for carrying information necessary for transmission of the ESG data. The broadcast ESG and the PTP ESG are transmitted to the at least one terminal over at least one delivery path out of the broadcast network and the interactive network.

According to another aspect of the present invention, a method for receiving an Electronic Service Guide (ESG) in a Convergence of Broadcasting and Mobile Service (CBMS) system is transmitted. ESG delivery information is received including at least one of a first information element indicating transmission of a broadcast ESG over a broadcast network and a second information element indicating transmission of a Point-to-Point (PTP) ESG for a terminal or a terminal group over an interactive network, over at least one ESG bootstrap session for carrying information necessary for transmission of ESG data, and parsing the received ESG delivery information. It is determined whether it will receive the broadcast ESG over the broadcast network or receive the PTP ESG over the interactive network according to the ESG delivery information. The broadcast ESG or the PTP ESG over the broadcast network or the interactive network is received according to the determination result.

According to a further aspect of the present invention, an apparatus is provided for transmitting an Electronic Service Guide (ESG) in a Convergence of Broadcasting and Mobile Service (CBMS) system. The apparatus includes an ESG entity for parsing a delivery path of ESG data, setting a first information element indicating transmission of a broadcast ESG when the ESG data can be delivered over a broadcast network, setting a second information element indicating transmission of a Point-to-Point (PTP) ESG for a terminal or a terminal group when the ESG data can be delivered over an interactive network in a PTP bearer, and transmitting ESG delivery information including at least one of the first and second information elements, to at least one terminal over at least one ESG bootstrap session for carrying information necessary for transmission of the ESG data. The apparatus also includes the broadcast network and the interactive network for transmitting the broadcast ESG and the PTP ESG to the at least one terminal according to the ESG delivery information.

According to yet another aspect of the present invention, an apparatus is provided for receiving an Electronic Service Guide (ESG) in a Convergence of Broadcasting and Mobile Service (CBMS) system. The apparatus includes a controller for receiving ESG delivery information including at least one of a first information element indicating transmission of a broadcast ESG over a broadcast network and a second information element indicating transmission of a Point-to-Point (PTP) ESG for a terminal or a terminal group over an interactive network, over at least one ESG bootstrap session for carrying information necessary for transmission of ESG data, parsing the received ESG delivery information, and determining whether it will receive the broadcast ESG over the broadcast network or receive the PTP ESG over the interactive network according to the ESG delivery information. The apparatus also includes at least one receiver for receiving the broadcast ESG or the PTP ESG over the broadcast network or the interactive network according to the determination result.

### BRIEF DESCRIPTION OF THE DRAWINGS

The above and other aspects, features and advantages of the present invention will become more apparent from the following detailed description when taken in conjunction with the accompanying drawings in which:

FIG. 1 illustrates a configuration of a CBMS system according to a preferred embodiment of the present invention;

FIG. 2 illustrates a data model of an ESG according to an embodiment of the present invention;

FIGS. 3A and 3B illustrate descriptors related to delivery of an ESG according to an embodiment of the present invention;

FIGS. 3C and 3D illustrate information formats of an ESG announcement carousel according to an embodiment of the present invention;

FIG. 3E illustrates two delivery bearers for an ESG according to an embodiment of the present invention;

FIG. 3F illustrates an example for a description of locations of the attributes according to an embodiment of the present invention;

FIG. 4 illustrates an operation of a network according to an embodiment of the present invention;

FIGS. 5 to 7 illustrate examples of a terminal's operation according to an embodiment of the present invention;

FIG. 8 illustrates a message flow according to an embodiment of the present invention;

FIG. 9 illustrates network architecture according to an embodiment of the present invention;

FIG. 10 illustrates terminal architecture according to an embodiment of the present invention;

FIGS. 11A to 11C illustrate structures of ESG bootstrap data according to an embodiment of the present invention;

FIGS. 12A to 14B illustrate structures of ESG bootstrap data according to an embodiment of the present invention; and

FIG. 15 illustrates a structure of a notification message according to an embodiment of the present invention.

### DETAILED DESCRIPTION OF THE PREFERRED EMBODIMENTS

Preferred embodiments of the present invention are described in detail with reference to the accompanying drawings. Detailed descriptions of constructions or processes known in the art may be omitted to avoid obscuring the subject matter of the present invention.

The embodiments of the present invention transmit an Electronic Service Guide (ESG) in a broadcast mode and/or a Point-to-Point (PTP) mode in a Convergence of Broadcasting and Mobile Service (CBMS) system. Specifically, to this end, information related to broadcast/PTP-mode transmission of the ESG is delivered to a terminal, and the terminal receives the ESG in a broadcast and/or PTP mode depending on the information.

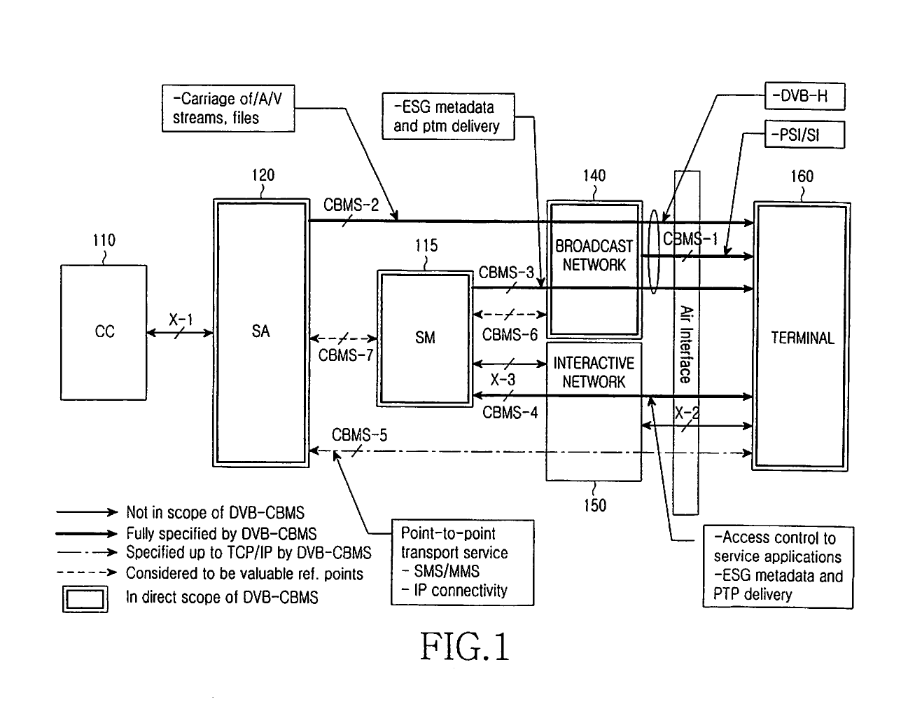

FIG. 1 illustrates a configuration of a CBMS system according to an embodiment of the present invention. Shown herein are logical entities interlinked to achieve the functions required for Internet Protocol (IP) Data Cast (IPDC) based on Digital Video Broadcasting—Handheld (DVB-H). The shown entities are divided according to their major functions, and are disposed in the physically divided servers or in the same server.

Referring to FIG. 1, a Content Creation block (CC) 110 generates content sources for a broadcast service, and sends the content sources to a Service Application block (SA) 120. The Service Application block 120 generates service data for a specific service by aggregating the content sources from the Content Creation block 110 and the metadata additionally necessary for service configuration. To this end, the Service Application block 120 consists of several sub-entities for managing different applications for each service. A Service Management block (SM) 115 includes sub-entities for performing service configuration, resource allocation, ESG provisioning, and security functions between the Service Application block 120 and a Terminal 160.

A Broadcast Network 140, a network for transmitting broadcast service data, is, for example, a DVB-H system. An Interactive Network 150 generally means a 3^{rd} Generation Partnership Project (3GPP)-based Universal Mobile Telecommunications System (UMTS), a 3^{rd} Generation Partnership Project-2 (3GPP2)-based International Mobile Telecommunications-2000 (IMT-2000) or Wireless Broadband Internet (WiBro), and a cellular mobile communication network such as Wireless Local Area Network (WLAN). As another example, the Interactive Network 150 can be all kinds of mobile communication networks that provide the function capable of receiving information or request transmitted from the Terminal 160 and transmitting a response to the information or request. The Broadcast Network 140 and the Interactive Network 150 serve as transmission bearers in the CBMS system.

The Terminal 160 means a user device, and indicates a receiver capable of accessing the Interactive Network 150 and receiving a broadcast service from the Broadcast Network 140. In the CBMS system, the Terminal 160 receives service data and signaling information from the Broadcast Network 140, and exchanges the service data and signaling information with the Interactive Network 150 in an interactive bearer.

A description will now be made of interfaces between entities including the foregoing logical entities.

CBMS-x and X-x are reference points between different functional entities. CBMS-x is a reference point in the scope of IP Datacast over DVB-H specification, and X-x is a reference point out of the scope of IP Datacast over DVB-H specification.

X-1, X-2 and X-3 interfaces mean reference points between the Broadcast Network 140 and other entities. The X-1 interface makes a connection between the Content Creation block 110 and the Service Application block 120, the X-2 interface makes a connection between the Interactive Network 150 and the Terminal 160, and the X-3 interface makes a connection between the Service Management block 115 and the Interactive Network 150.

A CBMS-1 interface transports broadcast-related signaling from the Broadcast Network 140 to the Terminal 160. A CBMS-2 interface transports the contents, such as audio, video and file, from the Service Application block 120 to the Terminal 160. A CBMS-3 interface transports an ESG from the Service Management block 115 to the Terminal 160 over the Broadcast Network 140 in a Point-to-Multipoint (PTM) transmission bearer. A CBMS-4 interface transports an ESG between the Service Management block 115 and the Terminal 160 in a PTP transmission bearer. A CBMS-5 interface, an interface for a PTP transmission service between the Service Application block 120 and the Terminal 160, transports Short Message Service (SMS), Multimedia Message Service (MMS), etc.

A CBMS-6 interface transports configuration parameters, such as the number of services and allocated bandwidths, between the Service Management block 115 and the Broadcast Network 140 for DVB-H transmission. A CBMS-7 interface transports declaration or metadata of a service application between the Service Application block 120 and the Service Management block 115.

Although the foregoing description is limited only to the typical functions of the interfaces, it is not intended to limit the functions of the interfaces to the foregoing description.

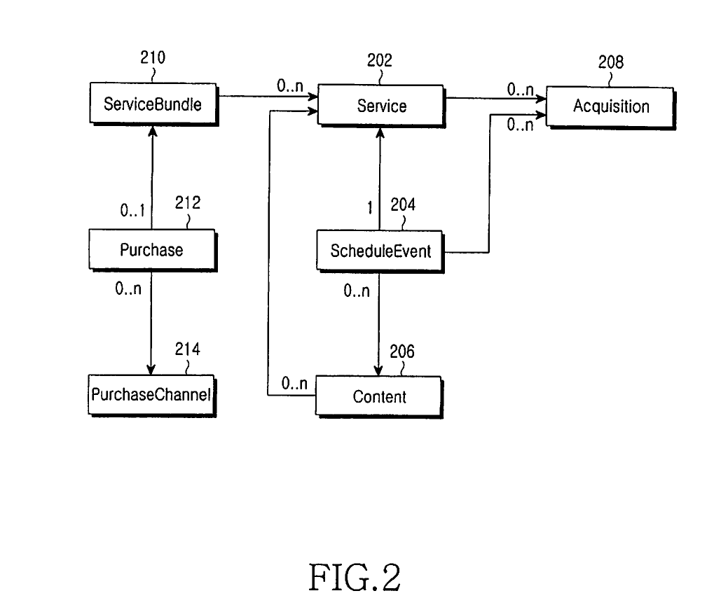

FIG. 2 illustrates a data model of an ESG according to a preferred embodiment of the present invention. As illustrated, the data model of the ESG is divided into multiple ESG fragments.

Referring to FIG. 2, the shown blocks indicate the fragments of the ESG data. That is, the ESG data model includes a Service fragment 202, a Schedule Event fragment 204, a Content fragment 206, an Acquisition fragment 208, a Service Bundle fragment 210, a Purchase fragment 212, and a Purchase Channel fragment 214.

The Service fragment 202 includes an overall description of the service. The Schedule Event fragment 204 indicates time information of the service. The Acquisition fragment 208 includes service access information needed to receive the service data. The Service Bundle fragment 210 includes information needed when several services are bundled into one service bundle. The Purchase fragment 212 indicates price information needed to purchase the service bundle. The Purchase Channel fragment 214 indicates information on the system that should be used to acquire a right for the purchase.

The fragments of the data model can make reference to other fragments, and an arrow between the fragments indicates the reference relationship. The term ‘reference’ refers to an action in which the current fragment provides information related to the fragment itself using information transmitted from another fragment. That is, when one service consists of several contents, the Service fragment 202 includes only the entire description of the service, for example, the service name and service language, and includes no description of the contents transmitted over the service, so the Content fragment 206 of the corresponding contents makes reference to the Service fragment 202. To acquire a variety of information needed to receive the service, for example, to acquire session information used for a transmission protocol, the terminal receives and decodes the Acquisition fragment 208 to which reference is made by the Service fragment 202.

The ESG data is transmitted separately to the terminal using at least one IP stream at a time different from the transmission time of a data stream. Therefore, a service provider can provide the information that the user should previously acquire before he/she receives the service using the ESG data model, before transmission of the service. By receiving the ESG stream, the terminal acquires the information necessarily needed to receive the services provided by the service provider, and when the user has selected a specific service, the terminal accesses the data stream over which the service is transmitted, using the acquired information, and then receives the data. The information based on which the terminal accesses the service data stream is transmitted over the Acquisition fragment 208 as described in FIG. 1.

As to the ESG data model, several fragments are grouped into one group and then contained in one container. Each container, during its transmission, is regarded as one object in a File Delivery over Unidirectional Transport protocol (FLUTE) session.

Although the ESG is generally delivered over a broadcast channel, a PTP ESG over the interactive network is needed to meet the commercial requirements. The PTP ESG is useful for the following cases where it is used only for some specific users.

In Case 1, it is more reasonable to deliver the ESG information for a personal finance service booked by some particular, in a PTP bearer. In Case 2, there is a need for transmission of the ESG information over the interactive network, when the user is out of the service coverage of the broadcast network but he/she still wants to consume the broadcast service over the interactive network. In Case 3, the ESG information for some services related to an interactive mode, such as game and shopping, is provided in a PTP bearer. In Case 4, it is more efficient to deliver the ESG information for roaming users in a PTP bearer, because it is for a small user group.

### First Embodiment

For reception of an ESG, a terminal discovers ESG providers by accessing an ESG bootstrap FLUTE session for carrying the information necessary for ESG delivery, and extracts and parses a concerned ESG Access Descriptor from one of the discovered ESG providers. Based on the ESG Access Descriptor, the terminal, if the user wants, immediately accesses the ESG over the broadcast network. In this case, there is only one of an ESG (hereinafter ‘broadcast ESG’) transmitted over the broadcast network and a PTP ESG transmitted over the interactive network, or there are both of the broadcast ESG and the PTP ESG Therefore, there is a need for a mechanism for providing the terminal with the information indicating whether an access type of the ESG is the broadcast ESG or the PTP ESG.

In the first embodiment, ESG Delivery information including a delivery path of a PTP ESG and its associated information is transmitted along with the information on a broadcast ESG over the existing ESG bootstrap session. The ESG Delivery information is also called ESG bootstrap information. In this case, related information for delivery of the broadcast ESG and PTP ESG is mixed in the information (hereinafter, referred to as ‘ESG bootstrap data’) transmitted over the ESG bootstrap session. Therefore, ‘ESGOverBroadcast’ and ‘ESGOverlnteractive’ are used, which are information elements that indicate whether ESG access over the broadcast network is available and whether ESG access over the interactive network is available, respectively. When the PTP ESG is used, information on the related ESG provider and access information are provided over the ESG Delivery information.

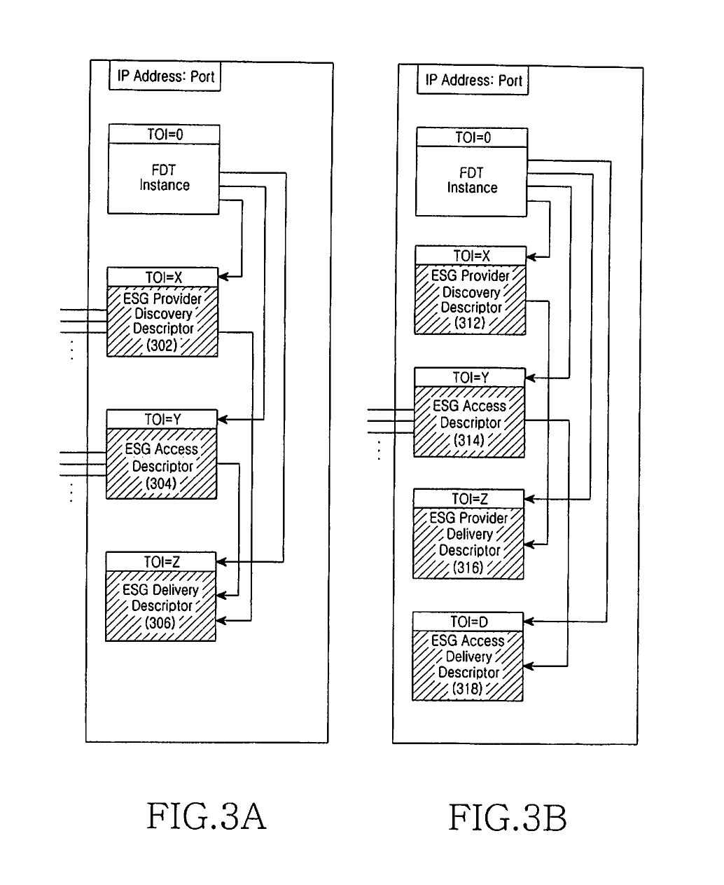

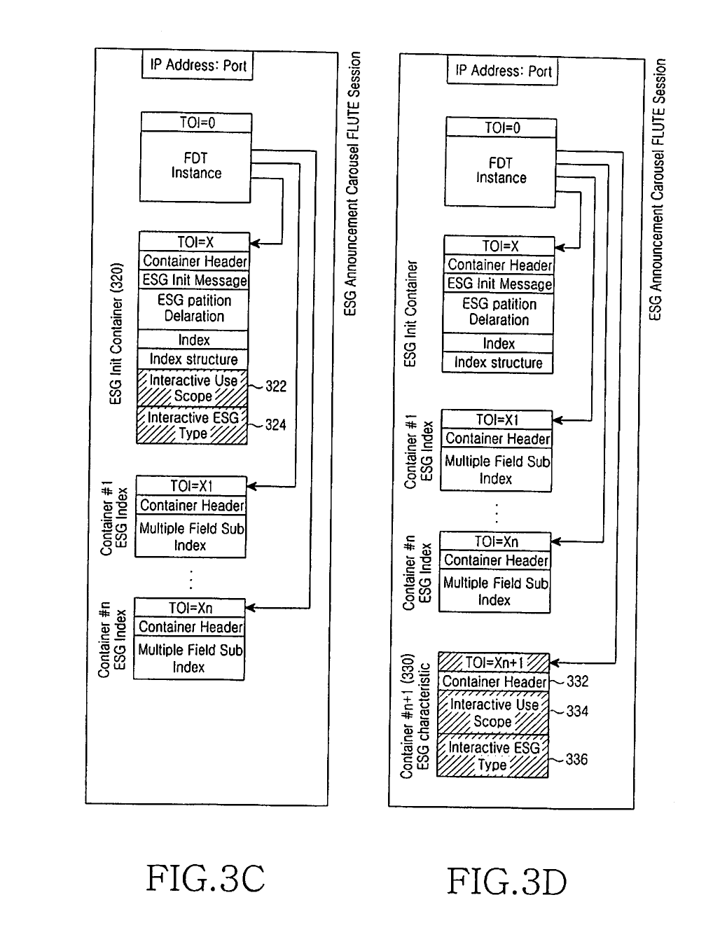

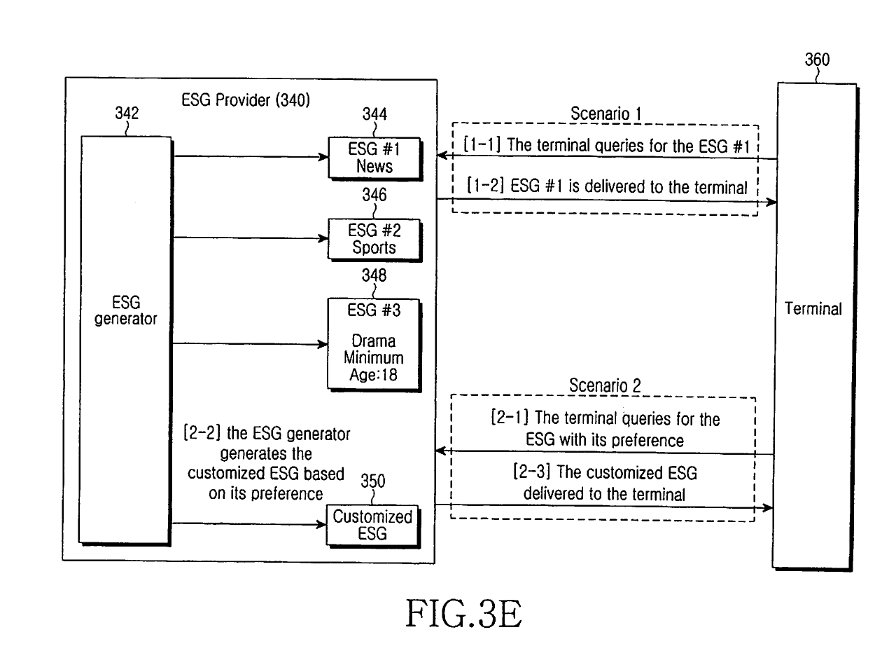

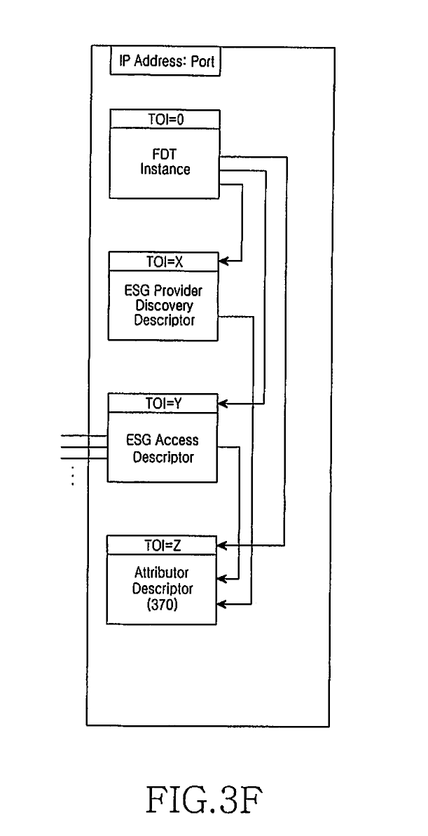

FIGS. 3A and 3B illustrate descriptors related to delivery of an ESG according to the first embodiment of the present invention. The descriptors are transmitted over the ESG bootstrap session along with information on a delivery bearer of the ESG.

Referring to FIG. 3A, when broadcast ESG and PTP ESG are introduced, a delivery path of each ESG and its related information are included in at least one of an ESG Provider Discovery Descriptor 302, an ESG Access Descriptor 304 and an ESG Delivery Descriptor 306 transmitted over the ESG bootstrap session.

Information elements of the ESG Provider Discovery Descriptor 302 including the ESG Delivery information are defined as follows.
‘ProviderURI’ specifies a Universal Resource Identifier (URI) for identifying an ESG provider. For example, the URI is a domain name of Internet Domain Name Service (DNS), registered by the ESG service provider, which uniquely identifies the service provider.
‘ProviderName’ specifies a name of the ESG provider in the textual format. The name, for example, is displayed to the user.
‘ProviderLogo’ specifies a representation of a promotional logo of the ESG provider.
‘ProviderID’ is to identify the ESG provider in the ESG Access Descriptor 304. The ESG provider registers the ProviderID at the authority that manages the bootstrapping channel to guarantee uniqueness.
‘ProviderInformationURL’ specifies a Uniform Resource Locator (URL) of more detailed information on the ESG provider.
‘PrivateAuxiliaryData’ specifies auxiliary data in a private format. This is an extension point, which can be used by the ESG provider for private data.
‘ESGOverBroadcast’ specifies the availability of ESG access over the broadcast channel. This attribute, if it is set to ‘true’, specifies that the ESG access over the broadcast network is available. This attribute, if it is set to ‘false’, specifies that the ESG access over the broadcast network is unavailable. An ESG provided over the broadcast network is called a broadcast ESG.
‘ESGOverlnteractive’ specifies the availability of ESG access over the interactive network. This attribute, if it is set to ‘true’, specifies that the ESG access over the interactive network is available. This attribute, if it is set to ‘false’, specifies that the ESG access over the interactive network is unavailable. A PTP ESG provided over the interactive network is called herein an interactive ESG.

The following information elements are provided over the ESG Provider Discovery Descriptor 302 when ‘ESGOverInteractive’ is ‘true’.
‘InteractiveProviderURI’ specifies a URI for uniquely identifying the interactive network provider.
‘InteractiveProviderName’ is a name of the interactive network provider in a textual format. The name, for example, is displayed to the user.
‘InteractiveProviderLogo’ specifies a representation of a promotional logo of the interactive network provider.
‘InteractiveType’ specifies the type of the interactive network, such as 3GPP, 3GPP2, WIBRO, and the like.
‘InteractiveProviderInformationURL’ specifies a URL of more detailed information on the interactive network provider.
‘InteractivePrivateAuxiliaryData’ specifies auxiliary data in a private format. This is an extension point, which can be used by the interactive network provider for private data.
‘InteractiveEntrypoint’ specifies the entry point for the interactive network. For example, it is a URL of a web site, or an interactive phone number.
‘InteractiveUseScope’ specifies the scope of the users that could access the ESG over the interactive network. For example, it is for the adults, or for the visited users.
‘InteractiveESGStartTime’ specifies the start time of the available interactive ESG
‘InteractiveESGEndTime’ specifies the end time of the available interactive ESG
‘InteractiveESGType’ specifies the type of the interactive ESG. For example, it indicates whether the ESG is about movie, or about news.

The information elements ‘ESGOverBroadcast’ and ‘ESGOverlnteractive’ are used to indicate whether the ESG access over the broadcast network is available and whether the ESG access over the interactive network is available, respectively, by setting them to ‘true’ or ‘false’ in the Boolean type. Therefore, three ESG access types ‘ESGAccessType’ are used, such as ‘broadcast’, ‘interactive’, and ‘both broadcast and interactive’.

‘InteractiveType’ can be 3GPP, 3GPP2, WLAN, WIBRO, and the like, and can be described by the types of the possible interactive networks. Although some possible interactive network types are listed herein, by bearer of example, new other types can be added. For example, the syntax of ‘InteractiveType’ is defined as Equation (1).

Equation (1)

```
<simpleType name=“InteractiveNetworkType”>
  <restriction base=“string”>
    <enumeration value=“3GPP”/>
    <enumeration value=“3GPP2”/>
    <enumeration value=“WLAN”/>
    <enumeration value=“WIBRO”/>
  </restriction>
</simpleType>
```

‘InteractiveUseScope’ can have many types. Although several types will be presented herein by bearer of example, more types can be defined by the system provider. Specifically, ‘InteractiveUseScope’ specifies the scope of the users that can access the ESG over the interactive network. For example, there is an ESG for the adults, or an ESG for the visited users.

The user scope has several types. For example, there are the following types, and the provider can define more types as they are required.

1) ParentalGuidanceType

Some services, such as movie and drama, are provided based on different age grades. In this case, the ESGs for these services are also provided based on the different age grades, as shown in Table 1A.

TABLE 1A

| InteractiveUseScope | Value |
|---|---|
| ParentalGuidanceType | ParentalRating, Minimum age |

2) User Origin

The services provided for the users from different origins can also be different from each other. For example, a first ESG is for specific local users, and a second ESG is for visited users, for example, for roaming users from regions A, B, . . . . The roaming users are specified according to the definition of handover and roaming in CBMS.

Table 1B shows some possible values for user origin, and it is based on IP platform, IPDC domain, nation, ESG provider, service provider, and Service Management (SM). The detailed values for the user origin can be modified according to the definition of roaming. If there is any new value about the user origin, it can also be added herein.

TABLE 1B

| InteractiveUseScope | Value | |
|---|---|---|
| User origin | 1. | local IP platform user |
| | 2. | roaming user from other IP platform |

| | |
|---|---|
| 2.1 | roaming user from IP platform A |
| 2.2 | roaming user from IP platform B |

| | |
|---|---|
| 3. | local IPDC domain user |
| 4. | roaming user from other IPDC domain |

| | |
|---|---|
| 4.1 | roaming user from IPDC domain A |
| 4.2 | roaming user from IPDC domain B |

| | |
|---|---|
| 5. | local nation (or area) user |
| 6. | visited user from other nation (or area) |

| | |
|---|---|
| 6.1 | visited user from nation (or area) A |
| 6.2 | visited user from nation (or area) B |

| | |
|---|---|
| 7. | local ESG provider user |
| 8. | roaming user from other ESG provider |

| | |
|---|---|
| 8.1 | roaming user from ESG provider A |
| 8.2 | roaming user from ESG provider B |

| | |
|---|---|
| 9. | local service provider user |
| 10. | roaming user from other service provider |

| | |
|---|---|
| 10.1 | roaming user from service provider A |
| 10.2 | roaming user from service provider B |

| | |
|---|---|
| 11. | local SM user |
| 12. | roaming user from other SM |

| | |
|---|---|
| 12.1 | roaming user from SM A |
| 12.2 | roaming user from SM B |

| | |
|---|---|
| 13. | reserved for future |

3) User Level

Different ESG can be provided based on the level of the user as shown in Table 1C. For example, a basic ESG is provided to general users, an ESG with rich previews is provided to registered users, and an ESG with user preference information is provided to VIP users.

TABLE 1C

| InteractiveUseScope | Value | |
|---|---|---|
| user level (User level) | 1. | general user |
| | 2. | registered user |
| | 3. | VIP user |
| | | 3.1 silver user |
| | | 3.2 golden user |
| | | 3.3 diamond user |

In summary, the message format is as shown in Table 2, but is not limited thereto. The format and terms in the following can be modified if needed during practical application.

TABLE 2

| 1 byte | 2 bytes | 32 bytes |
|---|---|---|
| 0x01: | ParentalRating | Minimum age |
| ParentalGuidanceType | | |
| 0x02: User origin | 0x0001: local IP platform user | IP platform ID |
| | 0x0002: roaming user from | IP platform ID |
| | other IP platform | |
| | 0x0003: local IPDC domain | IP platform ID, ESG provider |
| | user | ID, network ID |
| | 0x0004: roaming user from | IP platform ID, ESG provider |
| | other IPDC domain | ID, network ID |
| | 0x0005: local nation (or area) | Nation code (or area code) |
| | user | |
| | 0x0006: visited user from | Nation code (or area code) |
| | other nation (or area) | |
| | 0x0007: local ESG provider | ESG provider ID (provider URI |
| | user | and/or provider ID), IP |
| | | platform ID |
| | 0x0008: user from other ESG | ESG provider ID (provider URI |
| | provider | and/or provider ID), IP |
| | | platform ID |
| | 0x0009: local service provider | service provider URI and/or |
| | user | service provider ID |
| | 0x00010: user from other | service provider URI and/or |
| | service provider | service provider ID |
| | 0x0009: local SM user | SM identifier |
| | 0x00010: user from other SM | SM identifier |
| | provider | |
| | Reserved | |
| 0x03: user level | 0x0010: general user | None |
| | 0x0020: registered user | ESG identifier |
| | 0x0030: VIP user | ESG identifier |
| | 0x0031: silver | |
| | 0x0032: golden | |
| | 0x0033: diamond | |

ESG identification is needed because the characteristics of Table 2 are related to the ESG. There are several ESG identification ways. If one ESG provider has only one ESG instance, the ESG is identified using an ESG provider ID. If one ESG provider has multiple ESG instances, the ESG is identified using IP address, port, and TSI. In another way, a unique ID is allocated for each ESG instance within one ESG provider. Therefore, the ESG is identified via the ESG ID and ESG provider ID. Alternatively, the ESG is identified via ProviderURI and ProviderID.

For the local IPDC domain user, IP platform ID, ESG provider ID and network ID are used as the concept and identifier of the IPDC domain. In another case, new identifier parameters are used according to the concept of the IPDC domain.

The followings are some possible ways for identifying the SM according to the scenarios about CBMS mobility.

1. Service Provider ID

If one service provider has its own SM, the service provider ID is used to identify the SM.

2. ESG Provider ID

If each ESG provider is located in its own SM, ESG provider ID or the pair of ESG provider ID and the IP platform are used to identify the SM.

3. IP Platform ID

If one IP platform is exactly mapped to one SM, and different SMs cannot share one IP platform, the IP platform ID is used to identify the SM.

4. SM ID

To define the SM ID for each SM is the clearest way to identify each SM.

Although the foregoing description has been made of some types about InteractiveUseScope, it is not intended to limit the present invention thereto. The detailed types and values of InteractiveUseScope can be added as provider requirement and definition, and the purpose is to indicate the user scope of the ESG. Based on InteractiveUseScope, the terminal/user determines whether the corresponding ESG is available and whether it (he/she) will request the corresponding ESG. The user can determine from the InteractiveUseScope whether he/she is not in the use scope of the corresponding ESG, so he/she can avoid inquiring and getting the failure result.

InteracfiveESGType specifies the characteristic of the interactive ESG, for example, specifies as shown in Table 3A whether the ESG is about movie, or about news.

TABLE 3A

| | |
|---|---|
| InteractiveESGType | Value |

1. Sports
2. Soap Drama
3. News
4. Movies
5. Others

The ‘ServiceGenre’ criterion is used to classify different types of the ESG, for example, Sports, Soap Drama, News, Movie, and so one. Some typical genres are defined as the criterion value, and all other genres' services are treated as one.

In summary, although the message format for indicating the InteractiveESGType is as shown in Table 3B, it is not limited thereto. The format and types in the following can be modified if needed during practical application.

TABLE 3B

| 1 byte | 2 bytes |
|---|---|
| 0x01: ServiceGenre | 0x0001: Sports |
| | 0x0002: Soap Drama |
| | 0x0003: News |
| | 0x0004: Movies |
| | 0x0005: Others |

The foregoing is one kind of classification about the InteractiveESGType. The detailed types and values can be added as provider requirement and definition, and the purpose of the InteractiveESGType is to indicate the type of the ESG Based on InteractiveESGType, the terminal/user can very quickly find the ESG of the interested service/contents. The user can determine from the InteractiveESGType whether there is no interested ESG type, so he/she can avoid unnecessarily inquiring the interested ESG type.

From the foregoing description, it can be noted that both the InteractiveUseScope and the InteractiveESGType are specific for each ESG. For example, a first ESG includes news information for the roaming users, and a second ESG includes sports information for the local users. The above two elements are added inside the ESG initialization container (Init container) on the ESG announcement carousel session, or added in a new independent ESG characteristic container. The ESG initialization container, an ESG container first transmitted to carry the initialization information needed to decode the ESG fragments, basically includes a container header and an ESG initialization message.

FIGS. 3C and 3D illustrate two examples for locations in the ESG announcement carousel for InteractiveUseScope and InteractiveESGType. Referring to FIG. 3C, ‘InteractiveUseScope’ 322 and ‘InteractiveESGType’ 324 are included in an ESG initialization container 320. Referring to FIG. 3D, ‘InteractiveUseScope’ 334 and ‘InteractiveESGType’ 336 are included in an ESG characteristic container #(n+1) 330 among the ESG containers, along with a container header 332.

It is possible that there are multiple ESGs from one IP platform, and there are multiple ESGs even from one ESG provider. Such characteristics for each ESG provide more information on the corresponding ESG, and help the terminal determine in which ESG it is interested and whether it will query for the interested ESG.

If the terminal has its preferred ESG, it receives the customized ESG. That is, the terminal sends its preference to request its desired ESG. Then an ESG generator generates a customized ESG for the terminal, and sends it to the terminal.

FIG. 3E illustrates an example for a description of a difference between the ESG with some characteristics and the customized ESG. In the illustrated example, an ESG provider 340 provides three ESGs #1, #2 and #3 (344, 346 and 348) prepared by an ESG generator 342, and generates a customized ESG 350 if a terminal 360 queries it.

Scenario 1 is for a case of the ESGs 344 to 348 with characteristics. For each ESG, InteractiveUseScope and InteractiveESGType have been given to the terminal 360. Based on this information, if the terminal 360 has an interest about the news, it directly queries the ESG #1 344 [1-1]. When the ESG provider 340 receives the query message [1], the ESG #1 344 is delivered to the terminal 360 [1-2].

Scenario 2 is for a case of the customized ESG 350. The terminal 360 intends to receive the ESG with its preferred information. Therefore, the terminal 360 sends the query message with preference information [2-1]. Then the ESG generator 342 generates the customized ESG 350, or a new ESG based on the preference of the terminal 360 [2-2]. After the customized ESG 350 is generated, it is sent to the terminal 360 [2-3].

It can be found from the above examples that the ESGs 344 to 350 are differently used for the different purposes. Scenario 1 additionally provides the information on the ESG, and the information helps the terminal find its preferred ESG and quickly select it. Scenario 2 exactly satisfies the terminal's requirement, and increases the processing in the ESG provider because it should prepare the customized ESG for each user based on each terminal's preference.

The attributes, such as InteractiveType, InteractiveUseScope, InteractiveESGStartTime, InteractiveESGEndTime and InteractiveESGType, describe the characteristics about the ESG provider and the ESG over the interactive network, as shown in Table 4. Similarly, these attributes can be generalized to describe the characteristics about all kinds of ESG providers and ESGs over the broadcast and interactive networks.

TABLE 4

| Field | | | Description |
|---|---|---|---|
| BearerType | 0x01: | 0x01: DVB-H | Specifies the bearer for ESG |
| | Broadcast | 0x02: DVB-SH | delivery. It could be a |
| | bearer | 0x03: DAB | broadcast network. It could |
| | | 0x04: DMB | also be an interactive |
| | | 0x05: media FLO | network. |
| | | Others: reserved (any type | |
| | | of the broadcast bearer | |
| | | could be added here) | |
| | 0x02: | 0x01: 3GPP | |
| | interactive | 0x02: 3GPP2 | |
| | bearer | 0x03: WLAN | |
| | | 0x04: WIBRO | |
| | | Others: reserved (any type | |
| | | of the interactive bearer | |
| | | could be added here) | |
| | Others: | | |
| | reserved (any | | |
| | type of the | | |
| | bearer could | | |
| | be added | | |
| | here) | | |

| | | |
|---|---|---|
| UseScope | Reference InteractiveUseScop | Specifies the scope of the |
| | | users that could access the |
| | | ESG. For detailed |
| | | information, reference could |
| | | be made to the |
| | | InteractiveUseScope, and it |
| | | is just generalized to all of |
| | | the ESG provider and the |
| | | ESG. |
| ESGStartTime | Reference InteractiveESGStartTime | Specifies the start time of the |
| | | available ESG |
| ESGEndTime | Reference InteractiveESGEndTime | Specifies the end time of the |
| | | available ESG |
| ESGType | Reference InteractiveESGType | Specifies the characteristic of |
| | | the ESG. For example, it |
| | | cam be about the movies or |
| | | about the news. |
| Reserved | | Any new attribute could be |
| | | added. |

The attributes are generalized for both of the interactive and broadcast networks. The locations of these attributes are similar to those for ESG oIA, and they can be put in different locations in the ESG as described in the specification. That is, these attributes can be separated and put in different locations, or the attributes can also be organized together. FIG. 3F illustrates an example for a description of locations of the attributes according to a preferred embodiment of the present invention. As illustrated, if the attributes are organized together, they can be put in an independent descriptor 370, and the independent descriptor 370 is named an ‘attribute descriptor’.

The syntax of the ESG Provider Discovery Descriptor 302 with ESG Delivery information is defined as Equation (2).

Equation (2)

```
    <schema  targetNamespace=“urn:dvb:ipdc:esgbs:2005”
xmlns:bs=“urn:dvb:ipdc:esgbs:2005”  xmlns:mpeg7=“urn:mpeg:mpeg7:schema:2001”
xmlns=“http://www.w3.org/2001/XMLSchema”  elementFormDefault=“qualified”
attributeFormDefault=“unqualified”>
    <import namespace=“urn:mpeg:mpeg7:schema:2001” />
    <complexType name=“ESGProviderType”>
      <sequence>
        <element name=“ProviderURI” type=“anyURI”/>
        <element name=“ProviderName” type=“mpeg7:TextualType”/>
        <element  name=“ProviderLogo”  type=“mpeg7:TitleMediaType”
minOccurs=“0”/>
        <element name=“ProviderID” type=“positiveInteger”/>
        <element  name=“ProviderInformationURL”  type=“anyURI”
minOccurs=“0”/>
        <element  name=“PrivateAuxiliaryData”  type=“anyType”
minOccurs=“0”/>
        <element name=“InteractiveProviderURI” type=“anyURI”/>
        <element name=“InteractiveProviderName” type=“mpeg7:TextualType”/>
        <element  name=“InteractiveProviderLogo”
type=“mpeg7:TitleMediaType” minOccurs=“0”/>
        <element name=“InteractiveType” type=“esg: InteractiveNetworkType”>
        <element  name=“InteractiveProviderInformationURL”  type=“anyURI”
minOccurs=“0”/>
        <element  name=“InteractivePrivateAuxiliaryData”  type=“anyType”
minOccurs=“0”/>
        <element name=“InteractiveEntrypoint” type=“anyURI” minOccurs=“0”/>
        <element name=“InteractiveUseScope” type=“anyURI” minOccurs=“0”/>
        <element  name=“  InteractiveESGStartTime  ”  type=“dateTime”
minOccurs=“0”/>
        <element  name=“  InteractiveESGEndTime  ”  type=“dateTime”
minOccurs=“0”/>
        <element  name= “ InteractiveESGType  ”  type==“anyURI”
minOccurs=“0”/>
        <element name=“ ESGOverBroadcast” type=“boolean”/>
        <element name=“ ESGOverInteractive” type=“boolean”/>
      </sequence>
    </complexType>
    <element name=“ESGProviderDiscovery”>
    <complexType>
      <sequence>
        <element  name=“ServiceProvider”  type=“bs:ESGProviderType”
maxOccurs=“unbounded”/>
      </sequence>
    </complexType>
    </element>
    </schema>
```

The following specifies the information elements of the ESG Access Descriptor 304 with ESG Delivery information.
‘n_o_ESGEntries’ specifies the number of ESG Entries in which access information to ESGs is signaled.
‘ESGEntryVersion’ specifies the version of the ESG Entry Specification. This value should be set to a value of 2 or more when new information is added compared to the previous version. This version increases if the ESG Entry Specification is changed in a not-forward compatible way. A receiver should decode only the ESG Entries to which it complies.
‘ESGEntryLength’ specifies the length of the ESG Entry in bytes excluding the ‘ESGEntryVersion’ and ‘EntryLength’ fields. This allows forward compatible implementations even if fields are added to the ESG Access Descriptor 304 in the future.
‘MultipleStreamTransport’, if it is set to ‘1’, specifies a FLUTE session for transporting an Announcement Carousel Session, which is an ESG Delivery mechanism. This attribute, if it is set to ‘0’, specifies a FLUTE session containing all ESG containers of the ESG
‘IPVersion6’, if it is set to ‘1’, specifies that the ‘SourceIPAddress’ and ‘DestinationIPAddress’ are signaled according to IP version 6. This attribute, if it is set to ‘0’, specifies that the ‘SourceIPAddress’ and ‘DestinafionIPAddress’ are signaled according to IP version 4.
‘ProviderID’ is used to uniquely identify the ESG provider in the ESG Provider Discovery Descriptor 302. The ESG provider registers the ProviderID at the authority that manages the bootstrapping channel to guarantee uniqueness.
‘SourceIPAddress’ specifies the source IP address of the FLUTE session for transporting the ESG. The IP version of the source IP address is signaled by the ‘IPVersion6’ field.
‘DestinationIPAddress’ specifies the destination IP address of the FLUTE session for transporting the ESG. The IP version of the destination IP address is signaled by the ‘IPVersion6’ field.
‘Port’ specifies the port number of the IP Stream of the FLUTE session in which the ESG is transported.
‘TSI’ specifies the Transport Session Identifier (TSI) of the FLUTE session in which the ESG is transported.
‘ESGOverBroadcast’ specifies the availability of ESG access over the broadcast channel. This attribute, if it is set to ‘true’, specifies that the ESG access over the broadcast network is available. This attribute, if it is set to ‘false’, specifies that the ESG access over the broadcast network is unavailable.
‘ESGOverlnteractive’ specifies the availability of ESG access over the interactive network. This attribute, if it is set to ‘true’, specifies that the ESG access over the interactive network is available. This attribute, if it is set to ‘false’, specifies that the ESG access over the interactive network is unavailable.

The following information elements are provided over the ESG Access Descriptor 304 when ‘ESGOverInteractive’ is ‘true’.
‘InteractiveProviderURI’ specifies a URI for uniquely identifying the interactive network provider.
‘InteractiveProviderName’ is a name of the interactive network provider in a textual format. The name, for example, is displayed to the user.
‘InteractiveProviderLogo’ specifies a representation of a promotional logo of the interactive network provider.
‘InteractiveType’ specifies the type of the interactive network, such as 3GPP, 3GPP2, WIBRO, and the like.
‘InteractiveProviderInformationURL’ specifies a URL of more detailed information on the interactive network provider.
‘InteractivePrivateAuxiliaryData’ specifies auxiliary data in a private format. This is an extension point, which can be used by the interactive network provider for private data.
‘InteractiveEntrypoint’ specifies the entry point for the interactive network. For example, it is a URL of a web site, or an interactive phone number.
‘InteractiveUseScope’ specifies the scope of the users that could access the ESG over the interactive network. For example, it is for the adults, or for the visited users.
‘InteractiveESGStartTime’ specifies the start time of the available interactive ESG.
‘InteractiveESGEndTime’ specifies the end time of the available interactive ESG.
‘InteractiveESGType’ specifies the characteristic of the interactive ESG. For example, it indicates whether the ESG is about movie, or about news.

An example of the syntax of the ESG Access Descriptor 304 with ESG Delivery information is defined as Equation (3).

Equation (3)

```
ESG Access Descriptor{
  ESGOverBroadcast
  ESGOverInteractive
  InteractiveProviderURI
  InteractiveProviderName
  InteractiveProviderLogo
  InteractiveType
  InteractiveProviderInformationURL
  InteractivePrivateAuxiliaryData
  InteractiveEntrypoint
  InteractiveUseScope
  InteractiveESGStartTime
  InteractiveESGEndTime
  InteractiveESGType
  n_o_ESGEntries
  for(i=0; i<n_o_ESGEntries; i++){
    ESGEntry[i]( )
} }
```

Another example of the syntax of the ESG Access Descriptor 304 is defined as Equation (4).

Equation (4)

```
ESG Access Descriptor{
  n_o_ESGEntries
  for(i=0; i<n_o_ESGEntries; i++){
    ESGEntry[i]( )
    ESGOverBroadcast
    ESGOverInteractive
    InteractiveProviderURI
    InteractiveProviderName
    InteractiveProviderLogo
    InteractiveType
    InteractiveProviderInformationURL
    InteractivePrivateAuxiliaryData
    InteractiveEntrypoint
    InteractiveUseScope
    InteractiveESGStartTime
    InteractiveESGEndTime
    InteractiveESGType
} }
```

Further, another example of the syntax of the ESG Access Descriptor 304 is defined as Equation (5).

Equation (5)

```
ESGEntry{
  ESGEntryVersion
  ESGEntryLength
  MultipleStreamTransport
  IPVersion6
  Reserved
  ProviderID
  if(IPVersion6){
SourceIPAddress
DestinationIPAddress
  }else{
SourceIPAddress
DestinationIPAddress
  }
  Port
  TSI
  ESGOverBroadcast
  ESGOverInteractive
  InteractiveProviderURI
  InteractiveProviderName
  InteractiveProviderLogo
  InteractiveType
  InteractiveProviderInformationURL
  InteractivePrivateAuxiliaryData
  InteractiveEntrypoint
  InteractiveUseScope
  InteractiveESGStartTime
  InteractiveESGEndTime
  InteractiveESGType
}
```

As another embodiment, it is possible that a part of the ESG Delivery information is added in the ESG Provider Discovery Descriptor 302 and another part of the ESG Delivery information is added in the ESG Access Descriptor 304. In this case, the information elements added in the ESG Provider Discovery Descriptor 302 include ‘ProviderURI’, ‘ProviderName’, ‘ProviderLogo’, ‘ProviderID’, ‘ProviderInformationURL’, ‘PrivateAuxiliaryData’, ‘ESGOverBroadcast’, and ‘ESGOverlnteractive’. The ESG Access Descriptor 304 includes ‘n_o_ESGEntries’, ‘ESGEntryVersion’, ‘ESGEntryLength’, ‘MultipleStreamTransport’, ‘IPVersion6’, ‘ProviderID’, ‘SourceIPAddress’, ‘DestinationIPAddress’, ‘Port’, and ‘TSI’. When ‘ESGOverlnteractive’ is ‘true’, the ESG Access Descriptor 304 further includes ‘InteractiveProviderURI’, ‘InteractiveProviderName’, ‘InteractiveProviderLogo’, ‘InteractiveType’, ‘InteractiveProviderInformationURL’, ‘InteractivePrivateAuxiliaryData’, ‘InteractiveEntrypoint’, ‘InteractiveUseScope’, ‘InteractiveESGStartTime’, ‘InteractiveESGEndTime’, and ‘InteractiveESGType’. The description of the foregoing information elements has been made above.

The ESG Delivery Descriptor 306, a dedicated new descriptor for transporting the ESG Delivery information, includes information on each ESG provider, ‘ESGOverBroadcast’ and/or ‘ESGOverlnteractive’. When there is a PTP ESG, the related information is further added in the ESG Delivery Descriptor 306.

The ESG Delivery Descriptor 306 includes the information elements ‘ProviderURI’, ‘ProviderName’, ‘ProviderID’, ‘ESGEntryNo’, and ‘ESGOverBroadcast’, ‘ESGOverlnteractive’. Herein, ‘ESGEntryNo’ specifies a unique number of the ESG Entry, and is used when the conditional access is described for every ESG Entry.

When the ‘ESGOverlnteractive’ is ‘true’, the ESG Delivery Descriptor 306 further includes ‘InteractiveProviderURI’, ‘InteractiveProviderName’, ‘InteractiveProviderLogo’, ‘InteractiveType’, ‘InteractiveProviderInformationURL’, ‘InteractivePrivateAuxiliaryData’, ‘InteractiveEntrypoint’, ‘InteractiveUseScope’, ‘InteractiveESGStartTime’, ‘InteractiveESGEndTime’, and ‘InteractiveESGType’. The description of the foregoing information elements has been made before.

An example of the syntax of the ESG Delivery Descriptor 306 is defined as Equation (6).

Equation (6)

```
ESG Delivery Descriptor {
  ProviderURI
  ProviderName
  ProviderID
  ESGOverBroadcast
  ESGOverInteractive
  InteractiveProviderURI
  InteractiveProviderName
  InteractiveProviderLogo
  InteractiveType
  InteractiveProviderInformationURL
  InteractivePrivateAuxiliaryData
  InteractiveEntrypoint
  InteractiveUseScope
  InteractiveESGStartTime
  InteractiveESGEndTime
  InteractiveESGType
  n_o_ESGEntries
  for(i=0; i<n_o_ESGEntries; i++){
    ESGEntry[i]( )
} }
```

Another example of the syntax of the ESG Delivery Descriptor 306 is defined as Equation (7).

Equation (7)

```
ESG Delivery Descriptor {
  ProviderURI
  ProviderName
  ProviderID
  n_o_ESGEntries
  for(j=0;j<n_o_ESGEntries;j++){
  ESGEntry[i]( ){
  ESGOverBroadcast
  ESGOverInteractive
  InteractiveProviderURI
  InteractiveProviderName
  InteractiveProviderLogo
  InteractiveType
  InteractiveProviderInformationURL
  InteractivePrivateAuxiliaryData
  InteractiveEntrypoint
  InteractiveUseScope
  InteractiveESGStartTime
  InteractiveESGEndTime
  InteractiveESGType
}}}
```

Further, another example of the syntax of the ESG Delivery Descriptor 306 is defined as Equation (8).

Equation (8)

```
ESG Delivery Descriptor {
  ProviderURI
  ProviderName
  ProviderID
  n_o_ESGEntries
  for(i=0; i<n_o_ESGEntries; i++){
    If ( ESGOverBroadcast )
      ESGEntry{
      ESGEntryVersion
      ESGEntryLength
      MultipleStreamTransport
      IPVersion6
      Reserved
      ProviderID
      if(IPVersion6){
    SourceIPAddress
    DestinationIPAddress
    }else{
    SourceIPAddress
    DestinationIPAddress
    }
    Port
    TSI
Else if (ESGOverInteractive)
  InteractiveProviderURI
  InteractiveProviderName
  InteractiveProviderLogo
  InteractiveType
  InteractiveProviderInformationURL
  InteractivePrivateAuxiliaryData
  InteractiveEntrypoint
  InteractiveUseScope
  InteractiveESGStartTime
  InteractiveESGEndTime
  InteractiveESGType
} }
```

FIG. 3B illustrates a situation in which an ESG Provider Delivery Descriptor 316 and an ESG Access Delivery Descriptor 318 are used in addition to an ESG Provider Discovery Descriptor 312 and an ESG Access Descriptor 314 transported over the ESG bootstrap session. Compared to FIG. 3A, the ESG Delivery Descriptor 306 is divided into the two descriptors 316 and 318.

The syntax of the ESG Provider Delivery Descriptor 316 is defined as Equation (9).

Equation (9)

```
ESG Provider Delivery Descriptor {
  ProviderURI
  ProviderName
  ProviderID
  ESGOverBroadcast
  ESGOverInteractive
  InteractiveProviderURI
  InteractiveProviderName
  InteractiveProviderLogo
  InteractiveType
  InteractiveProviderInformationURL
  InteractivePrivateAuxiliaryData
  ...
}
```

The syntax of the ESG Access Delivery Descriptor 318 is defined as Equation (10).

Equation (10)

```
ESG Access Delivery Descriptor {
  n_o_ESGEntries
  for(i=0; i<n_o_ESGEntries; i++){
  ESGEntry[i]( )
  InteractiveEntrypoint
  InteractiveUseScope
  InteractiveESGStartTime
  InteractiveESGEndTime
  InteractiveESGType
} }
```

In the foregoing, the PTP ESG-related information elements are indicated in different locations, i.e. the ESG Provider Discovery Descriptors (302; 312), the ESG Access Descriptors (304; 314), and the unique descriptors (306; 316; 318). These descriptors 302 to 318 are used in an independent way or mixed way. For example, the ESG provider-related information is transmitted over the ESG Delivery Descriptor 306 or the ESG Provider Delivery Descriptor 316, and the ESG Entry-related information is transmitted over the ESG Access Descriptor 304, and vice versa. That is, various combinations based on the foregoing descriptors are possible.

The following information elements can be added in the ESG Delivery information, for purchase and information protection.
‘Free to air’ specifies whether the ESG is free of charring or it should be purchased for the ESG consuming.
‘Clear to air’ specifies whether the ESG is encrypted or not.
‘PurchaseRef’ specifies purchase-related information.
‘AcquisitionRef’ specifies the acquisition-related information.
‘RelatedEntrypoint’ specifies the related entry point that the terminal can enquire and get the right to consume the ESG.

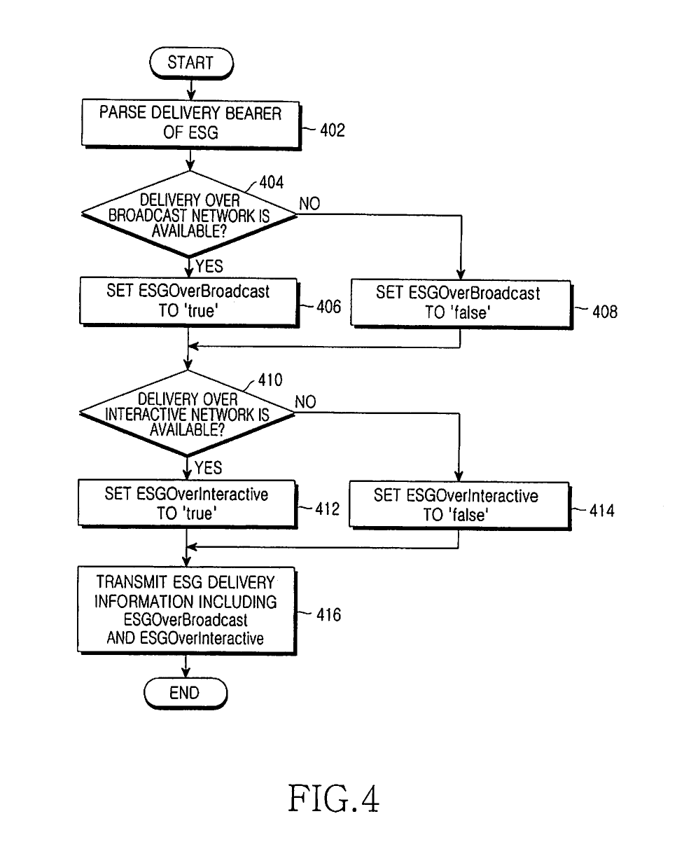

FIG. 4 illustrates an operation of a network according to an embodiment of the present invention.

Referring to FIG. 4, a network entity parses a delivery path of an ESG in step 402, and determines in step 404 whether the ESG can be delivered over a broadcast network. If the ESG can be delivered over the broadcast network, ‘ESGOverBroadcast’ to be included in the ESG Delivery information related to the ESG is set to ‘true’ in step 406. Otherwise, ‘ESGOverBroadcast’ is set to ‘false’ in step 408. The network entity determines whether the ESG can be delivered over an interactive network in step 410. If the ESG can be delivered over the interactive network, ‘ESGOverInteractive’ to be included in the ESG Delivery information is set to ‘true’ in step 412. Otherwise, the ESG Delivery information is set to ‘false’ in step 414. In step 416, the ESG Delivery information including the ‘ESGOverBroadcast’ and ‘ESGOverInteractive’ is transmitted from the network entity to a terminal. The ESG Delivery information, as described above, is carried on at least one of the descriptors 302 to 318 transmitted over the ESG bootstrap session. Thereafter, the ESG is transmitted to the terminal over a transmission bearer indicated by the ESG Delivery information.

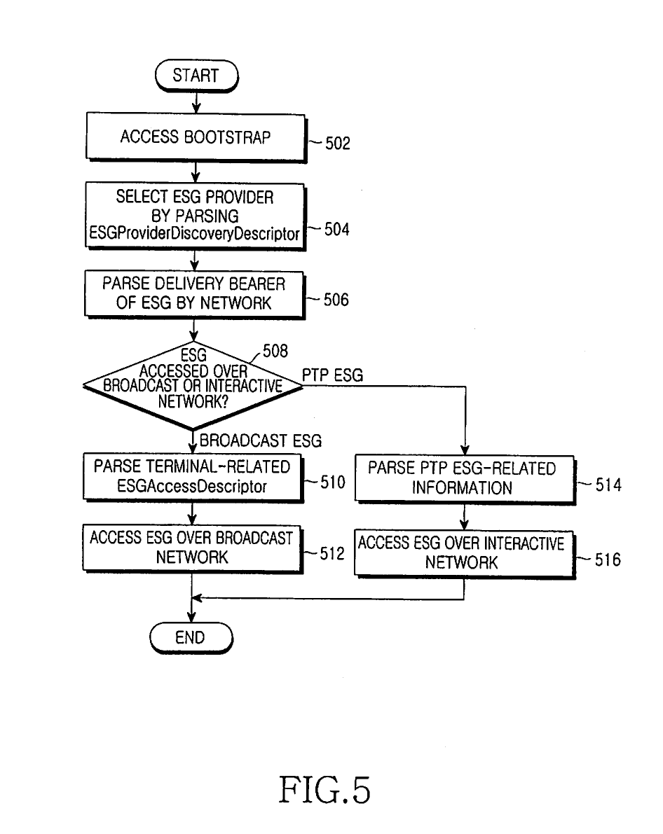

FIG. 5 illustrates an example of a terminal's operation according to an embodiment of the present invention. In this operation, the ESG Delivery information is carried in the ESG Provider Discovery Descriptors (302; 312).

Referring to FIG. 5, in step 502, a terminal accesses an ESG bootstrap session. In step 504, the terminal receives and parses an ESG Provider Discovery Descriptor over the ESG bootstrap session, and selects an ESG provider for the desired ESG. In step 506, the terminal parses an ESG Delivery bearer depending on ‘ESGOverBroadcast’ and ‘ESGOverlnteractive’, which are information elements included in the ESG Provider Discovery Descriptor.

In step 508, the terminal determines whether it will receive the ESG over a broadcast network or an interactive network, depending on the ESG Delivery bearer. If the terminal determines to receive a broadcast ESG over the broadcast network, it proceeds to step 510. However, if the terminal determines to receive a PTP ESG over the interactive network, it proceeds to step 514.

In step 510, the terminal parses an ESG Access Descriptor received over the ESG bootstrap session. In step 512, the terminal accesses the ESG over the broadcast network according to broadcast-related information included in the ESG Access Descriptor. In step 514, the terminal parses interactive-related information (i.e., PTP ESG-related information) included in the ESG Delivery information. In step 516, the terminal accesses the ESG over the interactive network according to the interactive-related information.

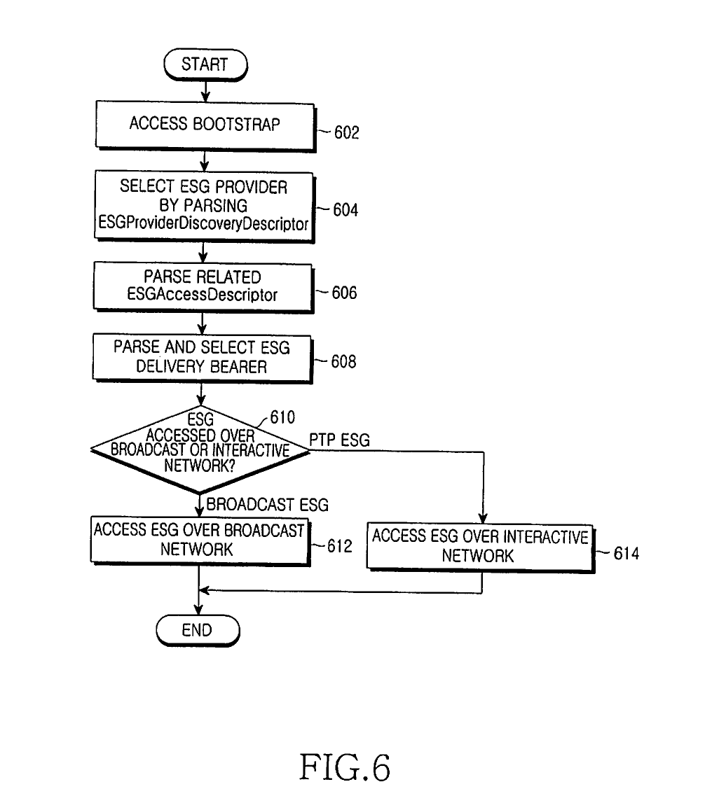

FIG. 6 illustrates another example of a terminal's operation according to an embodiment of the present invention. In this operation, the ESG Delivery information is carried in the ESG Access Descriptors (304; 314).

Referring to FIG. 6, in step 602, a terminal accesses an ESG bootstrap session. In step 604, the terminal receives and parses an ESG Provider Discovery Descriptor over the ESG bootstrap session, and selects an ESG provider for the desired ESG. In step 606, the terminal receives and parses an ESG Access Descriptor over the ESG bootstrap session. In step 608, the terminal parses an ESG Delivery bearer depending on ‘ESGOverBroadcast’ and ‘ESGOverlnteractive’, which are information elements indicating ESG Delivery information, included in the ESG Access Descriptor.

In step 610, the terminal determines whether it will receive the ESG over a broadcast network or an interactive network, depending on the ESG Delivery bearer. If the terminal determines to receive a broadcast ESG over the broadcast network, it proceeds to step 612. However, if the terminal determines to receive a PTP ESG over the interactive network, it proceeds to step 614.

In step 612, the terminal accesses the ESG over the broadcast network according to the broadcast-related information included in the ESG Access Descriptor. In step 614, the terminal accesses the ESG over the interactive network according to the interactive-related information included in the ESG Access Descriptor.

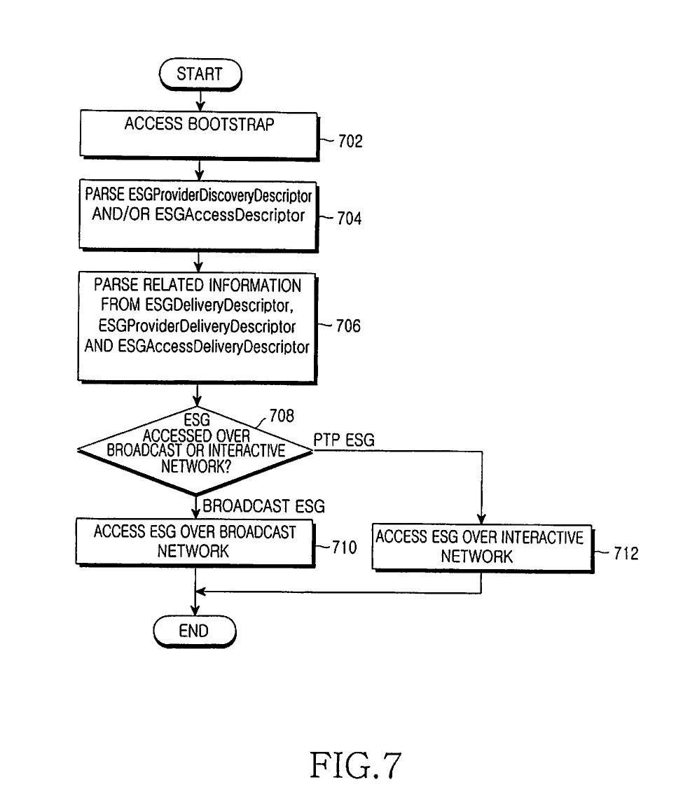

FIG. 7 illustrates a further example of a terminal's operation according to an embodiment of the present invention. In this operation, the ESG Delivery information is carried in ESG Delivery Descriptor 306 or ESG Provider/Access Delivery descriptors (316, 318).

Referring to FIG. 7, in step 702, a terminal accesses an ESG bootstrap session. In step 704, the terminal receives and parses ESG provider descriptor, ESG Provider Delivery Descriptor and/or ESG Access Delivery Descriptor over the ESG bootstrap session. In step 706, the terminal parses an ESG Delivery bearer depending on ‘ESGOverBroadcast’ and ‘ESGOverlnteractive’, which are information elements indicating ESG Delivery information, included in at least one descriptor.

In step 708, the terminal determines whether it will receive the ESG over a broadcast network or an interactive network, depending on the ESG Delivery bearer. If the terminal determines to receive a broadcast ESG over the broadcast network, it proceeds to step 710. However, if the terminal determines to receive a PTP ESG over the interactive network, it proceeds to step 712.

In step 710, the terminal accesses the ESG over the broadcast network according to the broadcast-related information included in the at least one descriptor. In step 712, the terminal accesses the ESG over the interactive network according to the interactive-related information included in the at least one descriptor.

The description has been made as to how the ESG Delivery information is added in the ESG Provider Discovery Descriptor, ESG Access Descriptor and/or new descriptor. However, the ESG Delivery information is not limited to the above-stated descriptors, and can be added in different locations or can be independently added. Similarly, even the contents included in the ESG Delivery information are not limited to the foregoing details, and more or modified information can be added as required by the operator.

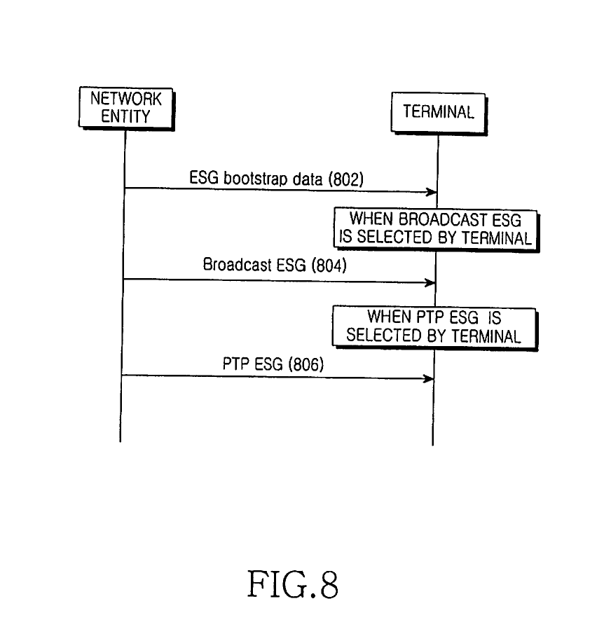

FIG. 8 illustrates a message flow according to the first embodiment of the present invention. As illustrated, in step 802, a network entity first carries ESG Delivery information on at least one descriptor of ESG bootstrap data transmitted over an ESG bootstrap session, and a terminal determines whether it will receive a broadcast ESG or a PTP ESG, depending on the ESG Delivery information. The ESG bootstrap data is assumed herein to include descriptors transmitted over the ESG bootstrap session. When the terminal selects the broadcast ESG, the terminal receives the ESG over the broadcast network in step 804. However, when the terminal selects the PTP ESG, the terminal receives the ESG over the interactive network in step 806.

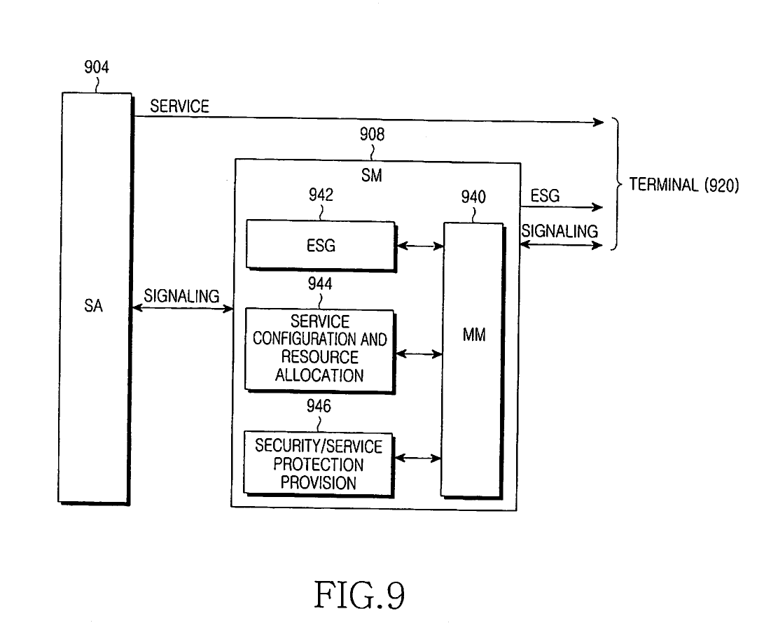

FIG. 9 illustrates architecture of a network according to an embodiment of the present invention. For simplicity, only the entities for performing the logical functions related to the preferred embodiment of the present invention in the network are shown in the drawing.

Referring to FIG. 9, a Service Application block (SA) 904 generates service data by aggregating broadcast contents from multiple sources and their related metadata to provide a specific service, encodes the service data in the format that a terminal can understand, and then provides the encoded service data to the terminal via streaming or file carousel delivery. Further, the SA 904 generates metadata including service description to be used in the ESG.

An ESG entity 942 in an SM 908 takes charge of generating and sending an ESG for each terminal or a terminal group using the metadata provided from the SA 904. Further, the ESG entity 942 generates and transmits ESG Delivery information according to the foregoing embodiments, and transmits the generated ESG over the broadcast network and/or interactive network.

A Service Configuration & Resource Allocation entity 944, in charge service configuration and allocation of network resources, contends for bandwidth for the broadcast bearer by communicating with the SA 904, allocates services to the locations on the broadcast network topology, determines service bandwidth, and schedules the service time. A Security/Service Protection Provision entity 946 takes charge of security, authentication, service protection, and service provisioning. The entities 942 to 946 are connected to a Mobility Management (MM) block 940 to perform functions necessary for handover. The MM block 940 performs operations related to mobility of the terminal, especially to handover and roaming.

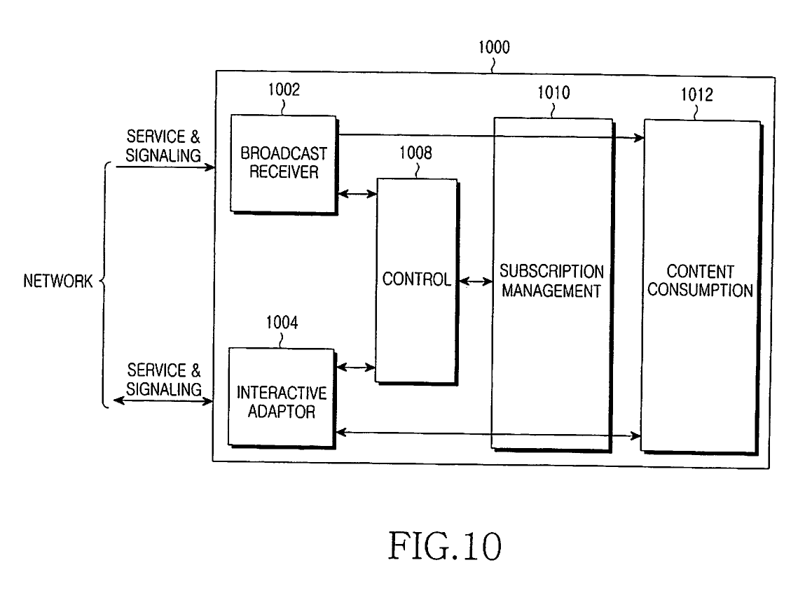

FIG. 10 illustrates architecture of a terminal receiver according to an embodiment of the present invention.

Referring to FIG. 10, a receiver 1000 includes not only a broadcast receiver 1002 capable of receiving a broadcast signal from the broadcast network, but also an interactive adaptor 1004 capable of accessing the interactive network. The broadcast receiver 1002 receives service data or signaling information from the broadcast network, and the interactive adaptor 1004 transmits/receives service data or signaling information over the interactive network. A control block 1008 performs a Mobility Management (MM) function of performing handover-related operations by interworking with a Subscription Management (SM) block 1010 in charge of management/acquisition of the terminal right related to the service subscription, and decryption of service contents. Meanwhile, according to the foregoing embodiments of the present invention, the control block 1008 acquires the ESG Delivery information and controls the broadcast receiver 1002 or the interactive adaptor 1004 depending on the ESG Delivery information to receive the ESG. In another case, the ESG Delivery information is provided to the user so that the ESG desired by the user can be selected.

At least one of the devices 1002 and 1004 receives the ESG over the broadcast network or the interactive network. The received ESG is delivered to a content consumption block 1012 that provides audio and video of the broadcast service to the user. The content consumption block 1012 immediately provides the received ESG to the user, or stores the ESG to provide it to the user in the future.

### Second Embodiment

A second embodiment splits the delivery information for PTP ESG and broadcast ESG into separate ESG bootstrap data, and transmits it over the same or separate FLUTE sessions. That is, the broadcast ESG Delivery information and the PTP ESG Delivery information can be separately delivered over different paths by their associated ESG providers. For the ESG Delivery information, at least one of ESG Delivery Descriptor, ESG Provider Delivery Descriptor and ESG Access Delivery Descriptor is used separately for each individual ESG provider.

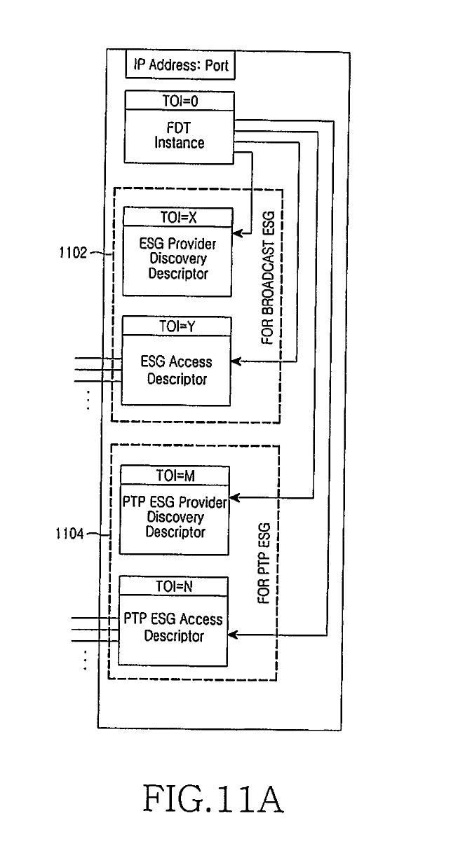

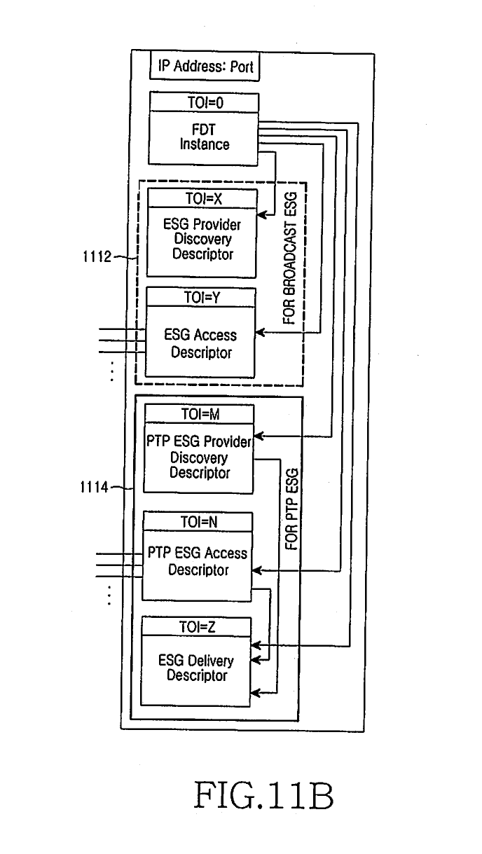

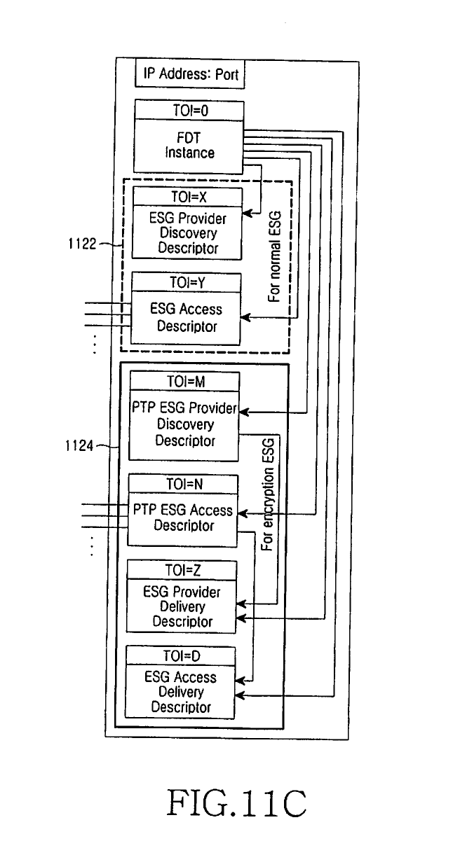

FIGS. 11A to 11C illustrate structures of ESG bootstrap data according to an embodiment of the present invention. As illustrated, all bootstrap information 1102 and 1112 for the broadcast ESG is transmitted over the ESG Provider Discovery Descriptor and the ESG Access Descriptor, while bootstrap information 1104 and 1114 for the PTP ESG is transmitted over other descriptors, i.e., at least one of the PTP ESG Provider Discovery Descriptor, the PTP ESG Access Descriptor and the ESG Delivery Descriptor. The bootstrap information 1102 to 1114 for the different ESGs is identified by different descriptor names, different Transport Object Identifiers (TOIs), or different label indications. The descriptors 1104 and 1114 for the PTP ESG are composed of the PTP ESG-related information elements similar to the information elements described in the first embodiment, except that the ‘ESGOverlnteractive’ is normally be set to ‘true’ or can be removed.

Shown in FIGS. 11A to 11C are structures of the ESG bootstrap data according to an embodiment of the present invention. Various examples of the detailed bootstrap information for the PTP ESG are shown herein, and the structures of the information 1102, 1112 and 1122 for the broadcast ESG have been described above.

In the example of FIG. 11A, the PTP ESG Delivery information 1104 is transmitted over the PTP ESG Provider Discovery Descriptor and the PTP ESG Access Descriptor. In the example of FIG. 11B, the PTP ESG Delivery information 1114 is transmitted over the PTP ESG Provider Discovery Descriptor, the PTP ESG Access Descriptor, and the ESG Delivery Descriptor. In the example of FIG. 11C, the PTP ESG Delivery information 1124 is transmitted over the PTP ESG Provider Discovery Descriptor and the PTP ESG Access Descriptor, and over the ESG Provider Delivery Descriptor and the ESG Access Delivery Descriptor. In FIGS. 11B and 11C, a part or all of the PTP ESG Delivery information is transmitted over the ESG Delivery Descriptor, the ESG Provider Delivery Descriptor and the ESG Access Delivery Descriptor.

The information elements transmitted over the foregoing descriptors for the PTP ESG are similar to those described in the first embodiment, but the ‘ESGOverInteractive’ can be set to ‘true’, or removed.

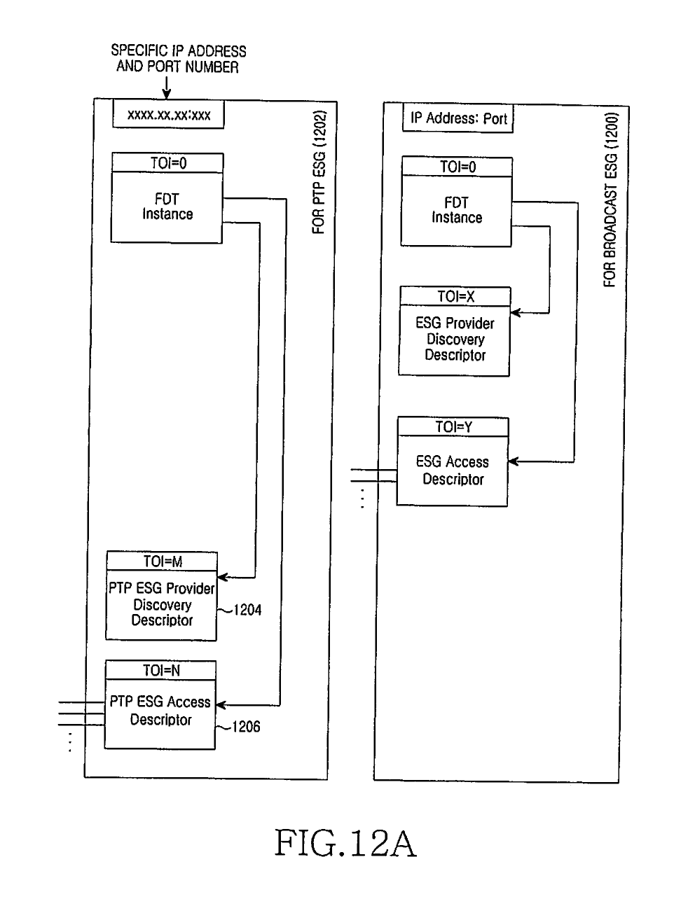

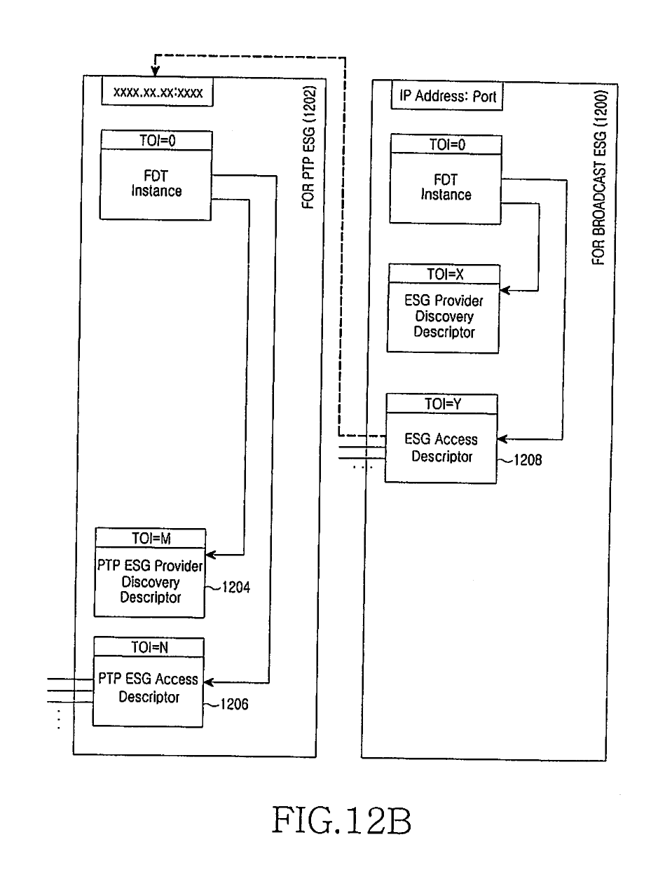

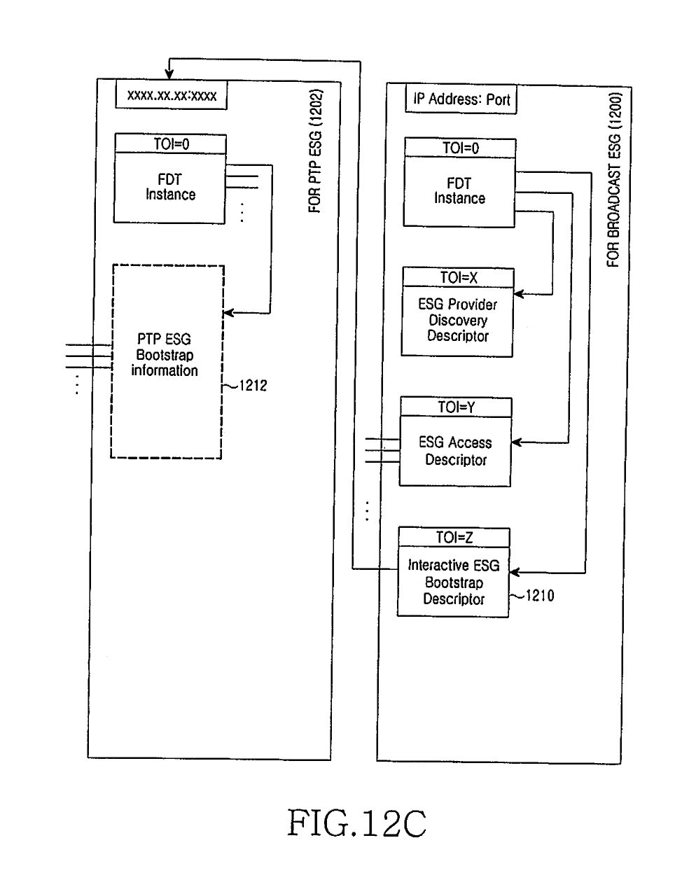

FIGS. 12A to 14B illustrate other structures of ESG bootstrap data according to an embodiment of the present invention. Shown herein are the structures in which the delivery information for the PTP ESG is transmitted over different FLUTE sessions, compared to the delivery information for the normal ESG. As illustrated, specific IP address and port number for the PTP ESG Delivery information are allocated to the additional PTP ESG bootstrap FLUTE sessions (1202; 1302; 1402). For example, the address information, such as the specific IP address and port number, is predetermined, or indicated by the normal ESG bootstrap data of the normal ESG bootstrap sessions (1200; 1300; 1400). When the address information is indicated by the normal ESG bootstrap data, the specific IP address and port number are included in ESG Access Descriptors (1208; 1308; 1412) of the normal ESG bootstrap data.

To indicate the PTP ESG bootstrap FLUTE sessions (1202; 1302; 1402), predetermined specific IP address and port number are allocated as shown in FIGS. 12A, 13A and 14A, and the terminal searches for the ESG Delivery information of the PTP ESG over the PTT ESG bootstrap FLUTE sessions (1202; 1302; 1402) using the specific IP address and port number. As another example, as shown in FIGS. 12B, 13B and 14B, IP address (xxxx.xx.xx) and port number (xxx) for the PTP ESG bootstrap FLUTE sessions (1202; 1302; 1402) are indicated in one descriptor, for example, ESG Access Descriptors (1208; 1308; 1412), of the normal ESG bootstrap session 1200.

In this case, an example of the syntax of the ESG Access Descriptors (1208; 1308; 1412) is defined as Equation (11).

Equation (11)

```
ESG Access Descriptor{
  n_o_ESGEntries
  for(i=0; i<n_o_ESGEntries; i++){
    ESGEntry[i]( )
    InteractiveESGBootstrapIPAddress
    InteractiveESGBootstrapPort
    InteractiveESGBootstrapTSI
}}
```

Another example of the syntax of the ESG Access Descriptors (1208; 1308; 1414) is defined as Equation (12).

Equation (12)

```
ESG Access Descriptor{
  InteractiveESGBootstrapIPAddress
  InteractiveESGBootstrapPort
  InteractiveESGBootstrapTSI
    n_o_ESGEntries
    for(i=0; i<n_o_ESGEntries; i++){
      ESGEntry[i]( )
} }
```

A modified embodiment, as shown in FIG. 12C, can add a new descriptor 1210 in the broadcast ESG bootstrap sessions (1200; 1300; 1400) to indicate the PTP ESG bootstrap FLUTE session. If the new descriptor 1210 is defined as an interactive ESG bootstrap descriptor ‘InteractiveESGBootstrapDescriptor’, the information elements shown in Table 5 are included in the interactive ESG bootstrap descriptor 1210.

TABLE 5

| Field | Semantics |
|---|---|
| InteractiveESGBootstrapIPAddress | Specifies the IP address of the FLUTE session |
| | transporting the interactive ESG bootstrap. |
| InteractiveESGBootstrapPort | Specifies the port number of the IP Stream of the |
| | FLUTE session in which the interactive ESG |
| | bootstrap is transported. |
| InteractiveESGBootstrapTSI | Specifies the transport session identifier (TSI) |
| | of the FLUTE session in which the interactive ESG |
| | bootstrap is transported. |

Shown in FIGS. 12A to 12C are examples for the case where PTP ESG bootstrap information 1212 indicating the PTP ESG Delivery information is transmitted over a PTP ESG Provider Discovery Descriptor (1204) and a PTP ESG Access Descriptor 1206. Particularly, shown in FIG. 12C is the interactive ESG bootstrap descriptor 1210 for indicating address information of the PTP ESG bootstrap session 1202 in the broadcast ESG bootstrap session 1200.

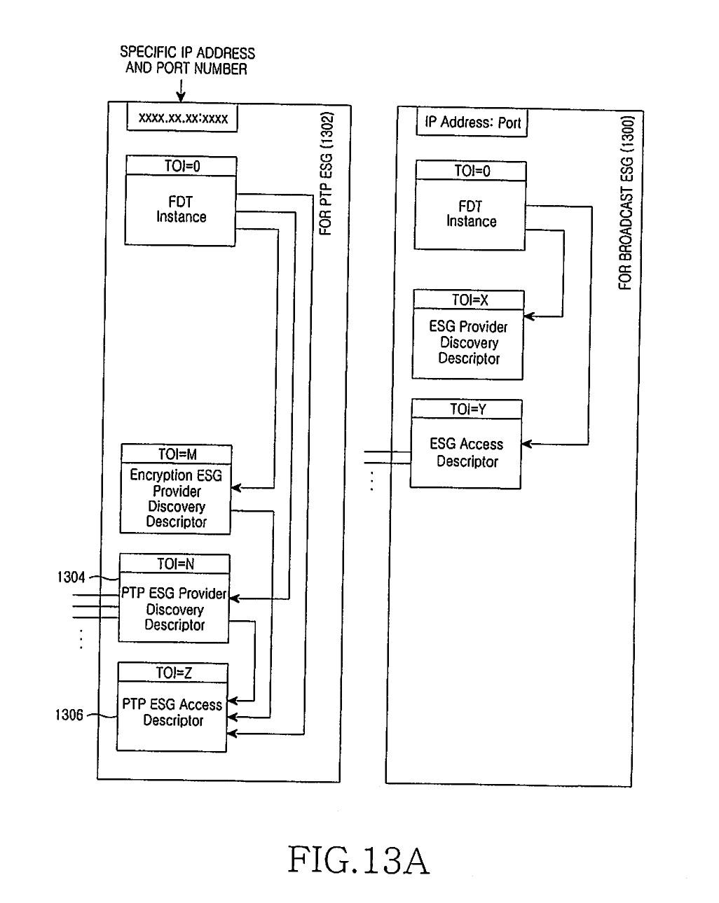

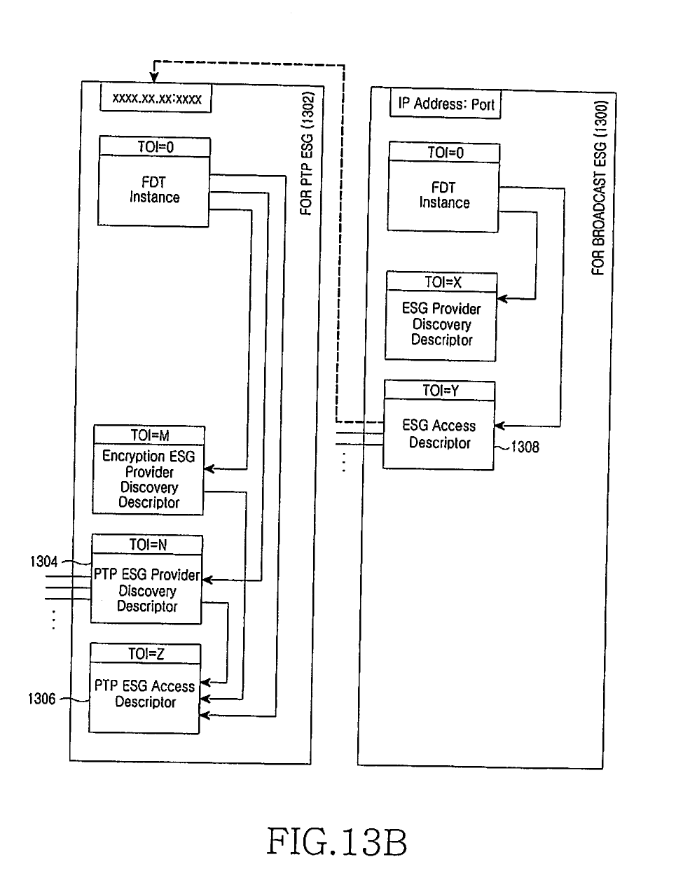

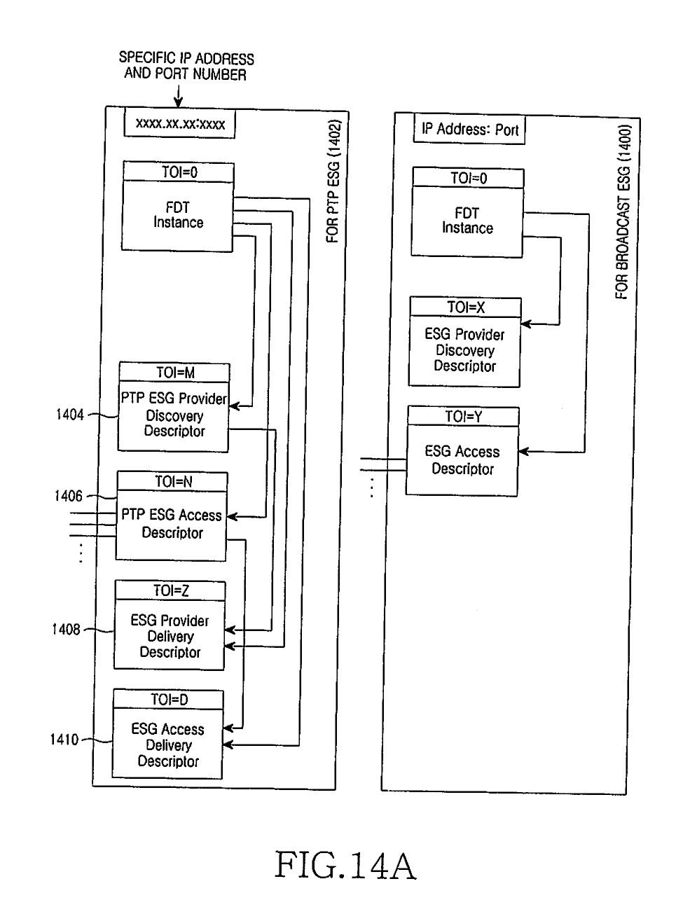

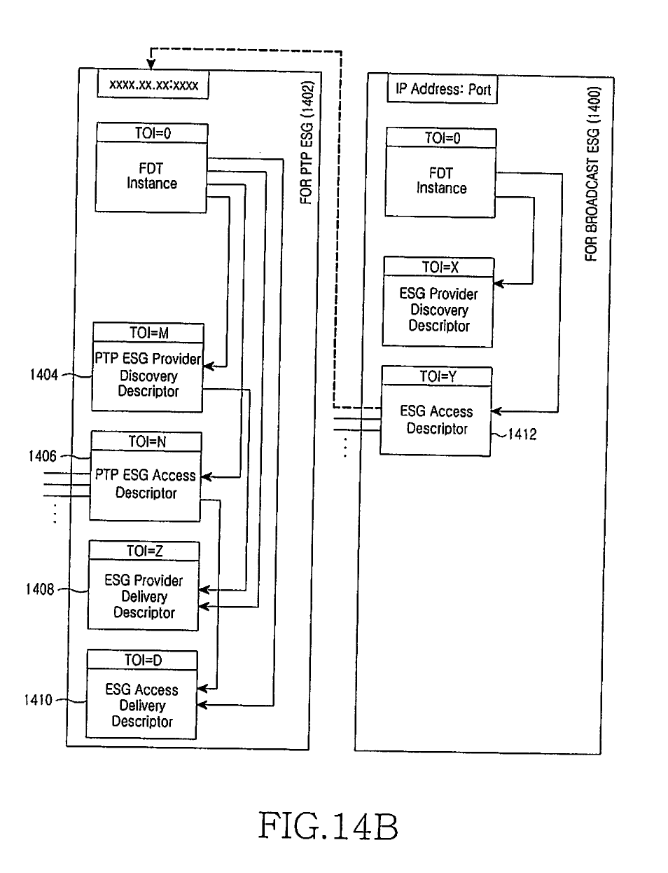

Shown in FIGS. 13A and 13B are examples for the case where the PTP ESG Delivery information is transmitted over the PTP ESG Provider Discovery Descriptor 1304 and PTP ESG Access Descriptor 1306 of the PTP ESG bootstrap session 1302. Shown in FIGS. 14A and 14B are examples for the case where the PTP ESG Delivery information is transmitted over the PTP ESG Provider Discovery Descriptor 1404, PTP ESG Access Descriptor 1406, ESG Provider Delivery Descriptor 1408, and ESG Access Delivery Descriptor 1410 of the PTP ESG bootstrap session 1402.

### Third Embodiment

According to a third embodiment, the PTP ESG Delivery information is transmitted over a notification message for indicating a change in the broadcast service and system.

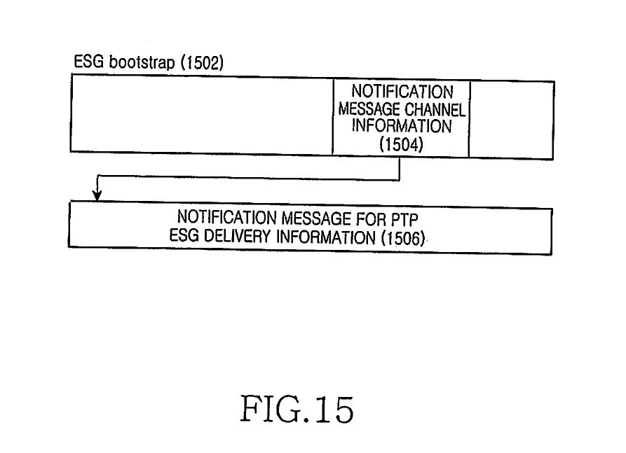

FIG. 15 illustrates a structure of a notification message according to an embodiment of the present invention. Shown herein is an example of the case notification message channel information 1504 indicating a delivery path of a notification message 1506 is transmitted over an ESG bootstrap session 1502. However, the notification message channel information 1504 can be transmitted in another delivery bearer, which is not mentioned herein.

In the illustrated example, a terminal receives the notification message channel information 1504 over the ESG bootstrap session 1502, and receives the notification message 1506 over the delivery path indicated by the notification message channel information 1504. The notification message 1506 includes a ‘EventType’ field in its header, and the ‘EventType’ is set to a value indicating ‘PTP ESG type’, when the PTP ESG Delivery information is transmitted over the notification message 1506. The detailed PTP ESG Delivery information is transmitted over the content of the notification message 1506.

The broadcast ESG Delivery information can be transmitted over the notification message 1506, either along with the PTP ESG Delivery information or independently. This transmission bearer is useful when the terminal, though it is out of the service coverage of the broadcast network, can receive the notification message over the interactive network. In this case, the terminal can acquire all ESG-related information, especially ESG bootstrap information related to delivery of the broadcast ESG and the PTP ESG, over the notification message 1506 related to the ESG bootstrap. The ‘EventType’ field of the notification message 1506 is set to a value indicating ‘ESGBootstrap’ or ‘ESGDelivery’, and ‘ESGOverBroadcast’ and ‘ESGOverlnteractive’ for indicating a delivery path for each ESG are included.

Table 6 shows an example of the notification message according to the third embodiment of the present invention.

TABLE 6

| EventType | Content of notification |
|---|---|
| PTP ESG Delivery information | ProviderURI |
| or | ProviderName |
| ESG bootstrap information | ProviderID |
| | ESGEntryNo |
| | ESGOverBroadcast |
| | ESGOverInteractive |
| | InteractiveProviderURI |
| | InteractiveProviderName |
| | InteractiveProviderLogo |
| | InteractiveType |
| | InteractiveProviderInformationURL |
| | InteractivePrivateAuxiliaryData |
| | InteractiveEntrypoint |
| | InteractiveUseScope |
| | InteractiveESGStartTime |
| | InteractiveESGEndTime |
| | InteractiveESGType |

As another example, when the ‘EventType’ field is not used, the PTP ESG Delivery information or all ESG bootstrap information is directly added in the content of the notification message as shown in Table 7.

TABLE 7
Content of notification

| | |
|---|---|
| PTP ESG Delivery information | ProviderURI |
| or | ProviderName |
| ESG bootstrap information | ProviderID |
| | ESGEntryNo |
| | ESGOverBroadcast |
| | ESGOverInteractive |
| | InteractiveProviderURI |
| | InteractiveProviderName |
| | InteractiveProviderLogo |
| | InteractiveType |
| | InteractiveProviderInformationURL |
| | InteractivePrivateAuxiliaryData |
| | InteractiveEntrypoint |
| | InteractiveUseScope |
| | InteractiveESGStartTime |
| | InteractiveESGEndTime |
| | InteractiveESGType |

A description of the information elements shown in Table 6 and Table 7 has been given above.

To access the ESG Delivery information, the terminal first accesses the notification message 1506 and receives the corresponding ESG over the interactive network depending on the PTP ESG Delivery information or all ESG bootstrap information obtained from the content of the notification message 1506. If the delivery of the notification message over the interactive network is the normal path (default bearer), the terminal automatically receives the notification message over the interactive network and directly acquires the ESG bootstrap information.

### Fourth Embodiment

In a fourth embodiment, the PTP ESG Delivery information is transmitted over the broadcast network or the interactive network using the independent signaling rather than the ESG bootstrap session. Table 8 shows the information elements of the PTP ESG Delivery information when the independent signaling is used. The PTP ESG Delivery information based on the independent signaling is provided by the network, when it is requested by the terminal.

The broadcast ESG Delivery information can be transmitted by the independent signaling, either along with the PTP ESG Delivery information or independently. This transmission is useful when the independent signaling is valid even though the terminal is out of the service coverage of the broadcast network. In this case, the terminal can acquire all ESG-related information, especially ESG bootstrap information related to delivery of the broadcast ESG and the PTP ESG, by the independent signaling. The ‘EventType’ field of the notification message 1506 is set to a value indicating ‘ESGBootstrap’ or ‘ESGDelivery’, and ‘ESGOverBroadcast’ and ‘ESGOverlnteractive’ for indicating a delivery path for each ESG are included.

TABLE 8

| Signaling Header | Signaling Content |
|---|---|
| PTP ESG Delivery information | ProviderURI |
| or | ProviderName |
| ESG bootstrap information | ProviderID |
| | ESGEntryNo |
| | ESGOverBroadcast |
| | ESGOverInteractive |
| | InteractiveProviderURI |
| | InteractiveProviderName |
| | InteractiveProviderLogo |
| | InteractiveType |
| | InteractiveProviderInformationURL |
| | InteractivePrivateAuxiliaryData |
| | InteractiveEntrypoint |
| | InteractiveUseScope |
| | InteractiveESGStartTime |
| | InteractiveESGEndTime |
| | InteractiveESGType |

A description of the information elements shown in Table 8 has been given above.

To access the ESG Delivery information, the terminal first receives and acquires the PTP ESG Delivery information or all ESG bootstrap information by independent signaling, and receives the corresponding ESG over the interactive network using the acquired information.

As is apparent from the foregoing description, the first embodiment delivers the ESG Delivery information over the ESG bootstrap session, for both the broadcast ESG and the PTP ESG. Although the second embodiment also delivers the ESG Delivery information over the ESG bootstrap session, because the ESG Delivery information is separated into the related information for the broadcast ESG and the related information for the PTP ESG or the information over different FLUTE sessions, the structure and information for the different ESG types are much clearer. However, because the terminal cannot obtain all ESG Delivery information at a time, there is a need to parse more descriptors. In some modified examples of the second embodiment, the terminal should identify the related information for the broadcast ESG and PTP ESG.

The third and fourth embodiments deliver the PTP ESG Delivery information or all ESG bootstrap information over the delivery path other than the ESG bootstrap session. The terminal obtains the broadcast ESG Delivery information and the PTP ESG Delivery information or the all ESG bootstrap information over different delivery paths, causing an increase in its processing complexity. However, in the third and fourth embodiments, the terminal can receive the PTP ESG Delivery information and/or the all ESG bootstrap information over the interactive network even when it cannot receive the broadcast signal.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting an Electronic Service Guide (ESG) in a Convergence of Broadcasting and Mobile Service (CBMS) system, the method comprising:
determining a delivery path of ESG data;
setting a first information element indicating transmission of a broadcast ESG when the ESG data can be delivered over a broadcast network;
setting a second information element indicating transmission of a Point-to-Point (PTP) ESG for a terminal or a terminal group when the ESG data can be delivered over an interactive network in a PTP bearer;
transmitting ESG delivery information including at least one of the first information element and the second information element, to at least one terminal over at least one ESG bootstrap session for carrying information necessary for transmission of the ESG data; and
transmitting at least one of the broadcast ESG and the PTP ESG to the at least one terminal over at least one delivery path of the broadcast network and the interactive network.

2. The method of claim 1, wherein the ESG delivery information comprises at least one of broadcast ESG delivery information related to the broadcast ESG transmitted over the broadcast network, and PTP ESG delivery information related to the PTP ESG transmitted over the interactive network.

3. The method of claim 2, wherein the ESG delivery information is transmitted over at least one of an ESG provider discovery descriptor, an ESG access descriptor, an ESG provider delivery descriptor and an ESG access delivery descriptor of the at least one ESG bootstrap session.

4. The method of claim 3, wherein the broadcast ESG delivery information and the PTP ESG delivery information are transmitted over different descriptors of a first ESG bootstrap session for carrying the broadcast ESG delivery information, and a second ESG bootstrap session for carrying the PTP ESG delivery information, respectively.

5. The method of claim 4, wherein the second ESG bootstrap session is transmitted using an Internet Protocol (IP) address and a port number, which are predetermined or indicated by an ESG access descriptor of the first ESG bootstrap session.

6. The method of claim 2, wherein the PTP ESG delivery information comprises at least one of ‘InteractiveUseScope’ indicating a scope of users capable of accessing the PTP ESG, and ‘InteractiveESGType’ indicating a characteristic of the PTP ESG;
wherein at least one of the ‘InteractiveUseScope’ and ‘InteractiveESGType’ is transmitted over an ESG initialization container for carrying initialization information required to decode the ESG data, or a dedicated ESG characteristic container.

7. The method of claim 6, wherein the ‘InteractiveUseScope’ indicates at least one of age grades, origins, levels and preferences of the users capable of accessing the PTP ESG.

8. The method of claim 1, wherein the ESG delivery information comprises at least one of:
‘ProviderURI’ indicating a Universal Resource Identifier (URI) for identifying an ESG provider of the broadcast ESG or the PTP ESG;
‘ProviderName’ indicating a name of the ESG provider in a textual format;
‘ProviderLogo’ indicating a representation of a promotional logo of the ESG provider;
‘ProviderID’ for identifying the ESG provider;
‘ProviderInformationURL’ indicating a Uniform Resource Locator (URL) of more detailed information on the ESG provider;
‘PrivateAuxiliaryData’ indicating auxiliary data in a private format provided by the ESG provider;
‘ESGOverBroadcast’ indicating an availability of ESG access over the broadcast network; and
‘ESGOverInteractive’ indicating an availability of ESG access over the interactive network.

9. The method of claim 8, wherein when the ‘ESGOverInteractive’ is set to ‘true’, the ESG delivery information further comprises at least one of:
‘InteractiveProviderURI’ indicating a URI for identifying an interactive network provider that provides the PTP ESG;
‘InteractiveProviderName’ indicating a name of the interactive network provider in a textual format;
‘InteractiveProviderLogo’ indicating a representation of a promotional logo of the interactive network provider;
‘InteractiveType’ indicating a type of the interactive network;
‘InteractiveProviderInformationURL’ indicating a URL of more detailed information on the interactive network provider;
‘InteractivePrivateAuxiliaryData’ indicating auxiliary data in a private format provided by the interactive network provider;
‘InteractiveEntrypoint’ indicating an entry point for the interactive network;
‘InteractiveUseScope’ indicating a scope of users capable of accessing the PTP ESG over the interactive network;
‘InteractiveESGStartTime’ and ‘InteractiveESGEndTime’ indicating a start time and an end time of the available PTP ESG; and
‘InteractiveESGType’ indicating a characteristic of the PTP ESG.

10. The method of claim 1, wherein the first and second information elements are transmitted over an ESG initialization container for carrying initialization information required to decode the ESG data, or a dedicated ESG characteristic container.

11. A method for receiving an Electronic Service Guide (ESG) in a Convergence of Broadcasting and Mobile Service (CBMS) system, the method comprising:
receiving ESG delivery information including at least one of a first information element indicating transmission of a broadcast ESG over a broadcast network and a second information element indicating transmission of a Point-to-Point (PTP) ESG for a terminal or a terminal group over an interactive network, over at least one ESG bootstrap session for carrying information necessary for transmission of ESG data, and parsing the received ESG delivery information;
determining whether it will receive the broadcast ESG over the broadcast network or receive the PTP ESG over the interactive network according to the ESG delivery information; and
receiving the broadcast ESG or the PTP ESG over the broadcast network or the interactive network according to the determination result.

12. The method of claim 11, wherein the ESG delivery information comprises at least one of broadcast ESG delivery information related to the broadcast ESG transmitted over the broadcast network, and PTP ESG delivery information related to the PTP ESG transmitted over the interactive network.

13. The method of claim 12, wherein the ESG delivery information is received over at least one of an ESG provider discovery descriptor, an ESG access descriptor, an ESG provider delivery descriptor and an ESG access delivery descriptor of the at least one ESG bootstrap session.

14. The method of claim 13, wherein the broadcast ESG delivery information and the PTP ESG delivery information are received over different descriptors of a first ESG bootstrap session for carrying the broadcast ESG delivery information, and a second ESG bootstrap session for carrying the PTP ESG delivery information, respectively.

15. The method of claim 14, wherein the second ESG bootstrap session is received using an Internet Protocol (IP) address and a port number, which are predetermined or indicated by an ESG access descriptor of the first ESG bootstrap session.

16. The method of claim 12, wherein the PTP ESG delivery information comprises at least one of ‘InteractiveUseScope’ indicating a scope of users capable of accessing the PTP ESG, and ‘InteractiveESGType’ indicating a characteristic of the PTP ESG;
wherein at least one of the ‘InteractiveUseScope’ and ‘InteractiveESGType’ is received over an ESG initialization container for carrying initialization information required to decode the ESG data, or a dedicated ESG characteristic container.

17. The method of claim 16, wherein the ‘InteractiveUseScope’ indicates at least one of age grades, origins, levels and preferences of the users capable of accessing the PTP ESG.

18. The method of claim 11, wherein the ESG delivery information comprises at least one of:
‘ProviderURI’ indicating a Universal Resource Identifier (URI) for identifying an ESG provider of the broadcast ESG or the PTP ESG;
‘ProviderName’ indicating a name of the ESG provider in a textual format;
‘ProviderLogo’ indicating a representation of a promotional logo of the ESG provider;
‘ProviderID’ for identifying the ESG provider;
‘ProviderInformationURL’ indicating a Uniform Resource Locator (URL) of more detailed information on the ESG provider;
‘PrivateAuxiliaryData’ indicating auxiliary data in a private format provided by the ESG provider;
‘ESGOverBroadcast’ indicating an availability of ESG access over the broadcast network; and
‘ESGOverInteractive’ indicating an availability of ESG access over the interactive network.

19. The method of claim 18, wherein when the ‘ESGOverlnteractive’ is set to ‘true’, the ESG delivery information further comprises at least one of:
‘InteractiveProviderURI’ indicating a URI for identifying an interactive network provider that provides the PTP ESG;
‘InteractiveProviderName’ indicating a name of the interactive network provider in a textual format;
‘InteractiveProviderLogo’ indicating a representation of a promotional logo of the interactive network provider;
‘InteractiveType’ indicating a type of the interactive network;
‘InteractiveProviderInformationURL’ indicating a URL of more detailed information on the interactive network provider;
‘InteractivePrivateAuxiliaryData’ indicating auxiliary data in a private format provided by the interactive network provider;
‘InteractiveEntrypoint’ indicating an entry point for the interactive network;
‘InteractiveUseScope’ indicating a scope of users capable of accessing the PTP ESG over the interactive network;
‘InteractiveESGStartTime’ and ‘InteractiveESGEndTime’ indicating a start time and an end time of the available PTP ESG; and
‘InteractiveESGType’ indicating a characteristic of the PTP ESG.

20. The method of claim 11, wherein the first and second information elements are received over an ESG initialization container for carrying initialization information required to decode the ESG data, or a dedicated ESG characteristic container.

21. An apparatus for transmitting an Electronic Service Guide (ESG) in a Convergence of Broadcasting and Mobile Service (CBMS) system, the apparatus comprising:
an ESG entity for parsing a delivery path of ESG data, setting a first information element indicating transmission of a broadcast ESG when the ESG data can be delivered over a broadcast network, setting a second information element indicating transmission of a Point-to-Point (PTP) ESG for a terminal or a terminal group when the ESG data can be delivered over an interactive network in a PTP bearer, and transmitting ESG delivery information including at least one of the first information element and the second information element, to at least one terminal over at least one ESG bootstrap session for carrying information necessary for transmission of the ESG data; and
the broadcast network and the interactive network for transmitting at least one of the broadcast ESG and the PTP ESG to the at least one terminal according to the ESG delivery information.

22. The apparatus of claim 21, wherein the ESG delivery information comprises at least one of broadcast ESG delivery information related to the broadcast ESG transmitted over the broadcast network, and PTP ESG delivery information related to the PTP ESG transmitted over the interactive network.

23. The apparatus of claim 22, wherein the ESG delivery information is transmitted over at least one of an ESG provider discovery descriptor, an ESG access descriptor, an ESG provider delivery descriptor and an ESG access delivery descriptor of the at least one ESG bootstrap session.

24. The apparatus of claim 23, wherein the broadcast ESG delivery information and the PTP ESG delivery information are transmitted over different descriptors of a first ESG bootstrap session for carrying the broadcast ESG delivery information, and a second ESG bootstrap session for carrying the PTP ESG delivery information, respectively.

25. The apparatus of claim 24, wherein the second ESG bootstrap session is transmitted using an Internet Protocol (IP) address and a port number, which are predetermined or indicated by an ESG access descriptor of the first ESG bootstrap session.

26. The apparatus of claim 22, wherein the PTP ESG delivery information comprises at least one of ‘InteractiveUseScope’ indicating a scope of users capable of accessing the PTP ESG, and ‘InteractiveESGType’ indicating a characteristic of the PTP ESG;
wherein at least one of the ‘InteractiveUseScope’ and ‘InteractiveESGType’ is transmitted over an ESG initialization container for carrying initialization information required to decode the ESG data, or a dedicated ESG characteristic container.

27. The apparatus of claim 26, wherein the ‘InteractiveUseScope’ indicates at least one of age grades, origins, levels and preferences of the users capable of accessing the PTP ESG.

28. The apparatus of claim 21, wherein the ESG delivery information comprises at least one of:
‘ProviderURI’ indicating a Universal Resource Identifier (URI) for identifying an ESG provider of the broadcast ESG or the PTP ESG;
‘ProviderName’ indicating a name of the ESG provider in a textual format;
‘ProviderLogo’ indicating a representation of a promotional logo of the ESG provider;
‘ProviderID’ for identifying the ESG provider;
‘ProviderInformationURL’ indicating a Uniform Resource Locator (URL) of more detailed information on the ESG provider;
‘PrivateAuxiliaryData’ indicating auxiliary data in a private format provided by the ESG provider;
‘ESGOverBroadcast’ indicating an availability of ESG access over the broadcast network; and
‘ESGOverInteractive’ indicating an availability of ESG access over the interactive network.

29. The apparatus of claim 28, wherein when the ‘ESGOverlnteractive’ is set to ‘true’, the ESG delivery information further comprises at least one of:
‘InteractiveProviderURI’ indicating a URI for identifying an interactive network provider that provides the PTP ESG;
‘InteractiveProviderName’ indicating a name of the interactive network provider in a textual format;
‘InteractiveProviderLogo’ indicating a representation of a promotional logo of the interactive network provider;
‘InteractiveType’ indicating a type of the interactive network;
‘InteractiveProviderInformationURL’ indicating a URL of more detailed information on the interactive network provider;
‘InteractivePrivateAuxiliaryData’ indicating auxiliary data in a private format provided by the interactive network provider;
‘InteractiveEntrypoint’ indicating an entry point for the interactive network;
‘InteractiveUseScope’ indicating a scope of users capable of accessing the PTP ESG over the interactive network;
‘InteractiveESGStartTime’ and ‘InteractiveESGEndTime’ indicating a start time and an end time of the available PTP ESG; and
‘InteractiveESGType’ indicating a characteristic of the PTP ESG.

30. The apparatus of claim 21, wherein the first and second information elements are transmitted over an ESG initialization container for carrying initialization information required to decode the ESG data, or a dedicated ESG characteristic container.

31. An apparatus for receiving an Electronic Service Guide (ESG) in a Convergence of Broadcasting and Mobile Service (CBMS) system, the apparatus comprising:
a controller for receiving ESG delivery information including at least one of a first information element indicating transmission of a broadcast ESG over a broadcast network and a second information element indicating transmission of a Point-to-Point (PTP) ESG for a terminal or a terminal group over an interactive network, over at least one ESG bootstrap session for carrying information necessary for transmission of ESG data, parsing the received ESG delivery information, and determining whether it will receive the broadcast ESG over the broadcast network or receive the PTP ESG over the interactive network according to the ESG delivery information; and
at least one receiver for receiving the broadcast ESG or the PTP ESG over the broadcast network or the interactive network according to the determination result.

32. The apparatus of claim 31, wherein the ESG delivery information comprises at least one of broadcast ESG delivery information related to the broadcast ESG transmitted over the broadcast network, and PTP ESG delivery information related to the PTP ESG transmitted over the interactive network.

33. The apparatus of claim 32, wherein the ESG delivery information is received over at least one of an ESG provider discovery descriptor, an ESG access descriptor, an ESG provider delivery descriptor and an ESG access delivery descriptor of the at least one ESG bootstrap session.

34. The apparatus of claim 33, wherein the broadcast ESG delivery information and the PTP ESG delivery information are received over different descriptors of a first ESG bootstrap session for carrying the broadcast ESG delivery information, and a second ESG bootstrap session for carrying the PTP ESG delivery information, respectively.

35. The apparatus of claim 34, wherein the second ESG bootstrap session is received using an Internet Protocol (IP) address and a port number, which are predetermined or indicated by an ESG access descriptor of the first ESG bootstrap session.

36. The apparatus of claim 32, wherein the PTP ESG delivery information comprises at least one of ‘InteractiveUseScope’ indicating a scope of users capable of accessing the PTP ESC, and ‘InteractiveESGType’ indicating a characteristic of the PTP ESG;
wherein at least one of the ‘InteractiveUseScope’ and ‘InteractiveESGType’ is received over an ESG initialization container for carrying initialization information required to decode the ESG data, or a dedicated ESG characteristic container.

37. The apparatus of claim 36, wherein the ‘InteractiveUseScope’ indicates at least one of age grades, origins, levels and preferences of the users capable of accessing the PTP ESG.

38. The apparatus of claim 31, wherein the ESG delivery information comprises at least one of:
‘ProviderURI’ indicating a Universal Resource Identifier (URI) for identifying an ESG provider of the broadcast ESG or the PTP ESG;
‘ProviderName’ indicating a name of the ESG provider in a textual format;
‘ProviderLogo’ indicating a representation of a promotional logo of the ESG provider;
‘ProviderID’ for identifying the ESG provider;
‘ProviderInformationURL’ indicating a Uniform Resource Locator (URL) of more detailed information on the ESG provider;
‘PrivateAuxiliaryData’ indicating auxiliary data in a private format provided by the ESG provider;
‘ESGOverBroadcast’ indicating an availability of ESG access over the broadcast network; and
‘ESGOverInteractive’ indicating an availability of ESG access over the interactive network.

39. The apparatus of claim 38, wherein when the ‘ESGOverlnteractive’ is set to ‘true’, the ESG delivery information further comprises at least one of:
‘InteractiveProviderURI’ indicating a URI for identifying an interactive network provider that provides the PTP ESG;
‘InteractiveProviderName’ indicating a name of the interactive network provider in a textual format;
‘InteractiveProviderLogo’ indicating a representation of a promotional logo of the interactive network provider;
‘InteractiveType’ indicating a type of the interactive network;
‘InteractiveProviderInformationURL’ indicating a URL of more detailed information on the interactive network provider;
‘InteractivePrivateAuxiliaryData’ indicating auxiliary data in a private format provided by the interactive network provider;
‘InteractiveEntrypoint’ indicating an entry point for the interactive network;
‘InteractiveUseScope’ indicating a scope of users capable of accessing the PTP ESG over the interactive network;
‘InteractiveESGStartTime’ and ‘InteractiveESGEndTime’ indicating a start time and an end time of the available PTP ESG; and
‘InteractiveESGType’ indicating a characteristic of the PTP ESG.

40. The apparatus of claim 31, wherein the first and second information elements are received over an ESG initialization container for carrying initialization information required to decode the ESG data, or a dedicated ESG characteristic container.
